(19) United States
(12) Patent Application Publication
(10) Pub. No.: US 2004/0115830 A1
(43) Pub. Date: Jun. 17, 2004

(54) Components for nano-scale Reactor

(76) Inventor: Igor Touzov, Cary, NC (US)

Correspondence Address: IGOR V TOUZOV, 311 CASTLE HAYNE DRIVE, CARY, NC, 27519, US

(21) Appl. No.: 10/605,354

(22) Filed: Sep. 24, 2003

Related U.S. Application Data
(60) Provisional application No. 60/413,927, filed on Sep. 25, 2002.

(51) Int. Cl. G01N 21/29

(52) U.S. Cl. 436/180; 422/100; 422/102; 422/82.05; 250/251; 385/16

(57) ABSTRACT

Microfluidic devices and methods for operations on micro through nano-meter scales. Methods of processing, handling and analysis of yocto-liter scale volumes. Methods and devices for single-molecule transports in milli-scale dimensions. Methods of laser propulsion of individual cells and droplets. Methods of packaging and manufacturing of micro and nanofluidic devices. Method of improving dispensing accuracy. Methods of uses and manufacturing of micro-optico-fluidic devices. Bottom up processing method. Ionic particle deflector device. Smart package device and methods for high-throughput synthesis and screening. Methods and devices for controlled refills of micro stamps. Methods and devices for insitu concentration and dilution of micro volumes of solids and liquids. Methods and devices for eliminating undesirable dry outs and evaporation of microscale volumes of fluids.

### CROSS REFERENCE TO RELATED APPLICATIONS

This application is a regular application of provisional Patent Application No. 60/413,927, filed Sep. 25, 2002 which is hereby incorporated by reference in its entirety for all purposes

### BACKGROUND OF INVENTION

Current state of the art in area of microfluidics that also includes plurality of assays for high-throughput synthesis and screening accounts for vide spectrum of methods, devices and assays all of which operate with relatively small amounts of liquids. Majority of said methods and devices use electric currents in form of electroosmotic propulsion of said liquids, while nearly as large number of said devices use pneumatic propulsion in form of pressure gradients. Only small number of methods was disclosed that engage different propulsion mechanisms. Method of heater induced propulsion was disclosed in U.S. Pat. No. 6,130,098 that employ variations in surface tension of liquid caused by array of heating elements. All aforementioned propulsion techniques are very robust in terms of insensitivity to composition of the liquid and presence of impurities on surfaces of said devices. Drawbacks of said methods include complex packaging of said devices that is handling tasks of interconnections of external electric and pneumatic/hydraulic lines, and complex manufacturing process that might require creation of complex 3D arrays of electrodes and/or electrical elements.

The present invention discloses plurality of methods and devices none of which required interfacing with external electrical/pneumatic/hydraulic lines. This clear distinction stands out this invention from plurality of prior art disclosures and secures novelty and nonobvious nature of methods and devices disclosed within. Among numerous advantages of present invention that will be disclosed in details later on, there is a general advantage that equally applicable to all embodiments of this invention. Absence of said interfaces reduces connection time required in conveyer-like operations with increase throughput of mass volume operations, and simplifies manufacturing of said devices that further draws down their cost, which also assigned to reduced use of metals.

The handling of micro volumes of a liquid susceptible to uncontrolled volume changes due to mass exchange caused by phase transition. This phenomenon imposes general restriction on types of acceptable processing types. Majority of disclosed techniques restrict processing of micro volumes to enclosed systems and dispenser type devices. Where dispenser carries macroscopic amount of a liquid usually exceeding microliter, and enclosed microfluidic systems perform processing of nano- and picoliter volumes at a time of reception. The present invention discloses new method and device associated with it that allow not only extended storage time of microscopic liquid volumes, but also permits geographically distributed processing of said volumes. So manufacturers of said devices can dispose said volumes and ship them for future processing to their clients.

Methods of fast parallel deposition of various compounds include microcontact printing technology that especially efficient in handling soluble compounds and liquids. Plurality of techniques for deposition of said compounds onto surface of micro stamp was disclosed in prior art U.S. Pat. Nos. 6,114,099, 5,512,131, which are limited to use of flat surfaces, and molds. The present invention discloses novel methods and devices to improve robustness and accuracy of said process. Major drawbacks of prior art methods comprise limited ability to control amount of compounds deposited on said stamp. Elegant approach for automated control of said process disclosed in the present invention.

Prior art contains numerous examples of use capillary forces at microscale. The main area of their application is in design of passive valves and similar devices. One other area of their wide use is converter devices capable of separating small fixed volumes (droplets) from larger continuous volumes of fluids. One of such devices has been disclosed in U.S. Pat. No. 6,130,098. It uses two hydrophobic regions to create micro droplet. Disclosed device requires external or internal source of gas as well as second pressure source that prevents backward motion of supplied fluids. Another disclosure of analogous device was made in U.S. Pat. No. 6,524,456. In this disclosure device uses only one hydrophobic region or not at all and uses sequential transport forces to move one or another immiscible fluids. Disclosed device does not have fixed means to guarantee equivalence of all produced micro volumes and relies on controlling means of electroosmotic propulsion. This approach has significant speed restrictions, since droplets formation can only occurs at speeds allowable by said switching force, not to mention that device construction requires plurality of electrodes and driving circuits.

The present invention proposes alternative methods and devices to solve task of segmentation of larger volumes of fluid onto smaller distinct microdroplets.

Another aspect of the present invention discloses method and devices for concentration of liquids in microfluidic devices. Prior art discloses devices and methods of insitu concentration. U.S. Pat. No. 5,869,004 discloses device and method that is based on electroosmotic concentration of conductive fluid interfacing with less conductive fluid. U.S. Pat. No. 6,007,690 discloses method operating on the same principle that uses different device construction. U.S. Pat. No. 6,475,441 discloses method and device that use the same principle. U.S. Pat. No. 6,558,523 uses same driving principle but uses electrodes as an ultimate separating interface. The goal of present invention is to allow efficient concentration of both polarizable and completely non-polar molecules or nano- and micro particles without affect on composition of surrounding liquid. Analytical techniques employed in microfluidic devices by prior art are represented by two classes of approaches. Chromatographic analysis that carries all benefits of capillary electrophoresis and broadly exploit in many technical publications and patents. Second class represents spectral analysis that is natural transition of macro-scale spectrometry to new micro-dimensional frontier. This subject is also exploited in great details by scientific and technical communities. Other approaches include mass-spectrometry and NMR. The present invention discloses original analytical and processing method and devices that implement its use. This method is based on discrimination of micro volumes of fluid based on their integral characteristics. Benefits of this invention include efficient sorting and dispensing of micro fractions based on their physical and chemical characteristics and also characterization of chemical composition of said micro volumes.

The present invention discloses new approach to control of phase transitions between micro volumes of liquids and gaseous phase. Prior art work in this area employs two systematic approaches. One approach based on restriction of exposure of said liquids to said gaseous environment and results in design of encloses devices for handling of said liquids. Another approach results in efforts of creating controlled gaseous environment. It allows regulation of material exchange between said micro volumes of liquids and said gaseous environment. This approach results in creation of environment chambers that control composition of volume of gaseous phase. Both approaches nevertheless have some weaknesses. Enclosed systems approach requires design of complex interfaces for said microfluidic devices that allow fluids exchange. Environmental chamber approach requires of enclosure of third party equipment (such as jet micro dispenser) in said chamber, and nevertheless it unable to completely stop evaporation of said micro volumes of fluids since it requires nearly saturated vapors, and such conditions are unstable in macroscopic volumes.

The present invention discloses methods and devices that create micro space of controlled gaseous environment in direct interface with said surfaces of fluids. Invented approach allows precisely control even oversaturated vapor conditions.

The present invention discloses new concept of microfluidic devices that manipulate micro droplets of fluids that have larges geometrical dimension smaller than smallest geometrical dimension of micro channel it resides in. Concept of manipulating micro droplets of fluid in microfluidic field was disclosed in prior art U.S. Pat. No. 6,540,896, nevertheless inventors create laminar flow of liquid that controls motion of said droplets, such approach does not allows handling of very small volumes since their integrity quickly deteriorates due to diffusion into of said flow components. Present invention incorporates use of focused laser beams to manipulate said micro volumes. Method of manipulating micro volumes using sources of electromagnetic radiation was disclosed in U.S. Pat. No. 6,573,491. Said disclosure however focuses on use of radiofrequency energy, microwave energy and infrared light to produce dipole force that creates trap at fluid-substrate interface and moving said trap along desired vector. The present invention however uses two different approaches to achieve efficient manipulation of said micro volumes. One approach uses absorption of infrared, visible or UV laser radiation by compounds compositing said micro volume, and use of created photonic pressure to move said micro volumes in direction of vector of energy propagation. Another approach uses Marangoni effect that is created by dynamic creation of single or two dimension thermal waves in said microfluidic device. Disclosed approaches results in methods and devices disclosed in the present invention.

Current state of the art discloses plurality of approaches for serial and parallel processing of large numbers of microfluidic devices. Each such approach requires establishing of some interface between processing equipment and said microfluidic device. Said interface can be as simple as appropriate geometrical placement of said microfluidic device or may include electrical, hydraulic, optical and other interfaces. In serial processing important factor of fast and successful operations is compensation for discrepancies that may exist between said devices. The present invention discloses novel approach that crated efficient means for said compensation.

### SUMMARY OF INVENTION

One embodiment of the present invention discloses microfluidic device capable of receiving microscopic volume of a liquid sample from an external dispensing source and preserve said sample in liquid phase of same solvent over prolonged period of time that required for transport of said device to location where further processing or use of said liquid sample will be performed.

Yet another embodiment of the present invention discloses apparatus and methods of its use, where in said apparatus allows repetitive parallel deposition of controlled amount of liquids onto selected surface segments of stamps involved in microcontact printing. This invention dramatically improves robustness of microcontact printing method and expands its applications.

One of embodiments of the present invention discloses method and device for segmentation of fluids onto smaller identical fixed volumes, and said device is capable of operation at high throughput to produce sequence of said micro volumes separated by immiscible fluid.

In one embodiment the present invention discloses apparatus that uses surface features of substrate instead of microchannels to transport micro volumes of fluids and perform chemical reactions. This invention provides advantages in design of flexible multiway microfluidic devices that require minimal use of enclosed chambers and microchannels.

One embodiment discloses method of passive transport of micro volumes inside microfluidic devices that employs processes of diffusion and absorption of amphiphilic chemicals by said minute volumes of fluids. This invention is useful for plurality implementations of microfluidic devices. In particular applications of synthesis of compounds when electroosmotic driving mechanism is hard to implement due to reactivity of contact material this invention provides efficient low cost alternative.

Yet another embodiment of the present invention discloses method of selective passive discrimination of micro droplets based on their chemical composition. Distinct advantage of devices that implement this method is their ability to discriminate very small (up to one zeptoliter) droplets of fluid in microfluidic systems.

One embodiment discloses method for controlling of oversaturated vapors in direct interface with micro volumes of non-enclosed fluids. It also disclosed apparatus that enables said control. Invented method allows separation between environment condition of third party equipment and environment conditions required for stability of micro volumes of non-enclosed fluids. Said techniques allows dispensing of multimillion arrays of microdroplets onto microfluidic devices that can be sustained in liquid state without dry out over virtually any time that may be required for said dispensing.

Yet another embodiment of the present invention discloses method of manipulation of micro volumes of a substance that can be as small as one yoctoliter and even composed of a single molecule. Said method employs use of Marangoni effect and dynamically indices thermal waves produced in substrate by means of focused laser radiation. It is been found that this technique operates more efficiently of substrates having low affinity to said substance.

Source of focused laser radiation of infrared trough ultraviolet range is employed as a part of yet another embodiment of the present invention. This invention uses microfluidic device with plurality of fiber optic interfaces that direct high power laser radiation into channels and chambers of said microfluidic device. This invention uses photonic pressure to propel micro volumes of fluids in said device, perform concentration and of material inside said device and reduce non-specific binding of chemicals to surfaces of said microfluidic device.

One of the embodiments of the present invention discloses smart microfluidic device that comprises static memory module carrying data specific to said microfluidic device, thus providing efficient means for its processing.

Definitions

Optical fiber is a device capable of transmitting electromagnetic energy in form of light with wavelength in of infrared, visible or UV range, wherein term transmission means that at least one percent of said energy that enters the device leaves said device in the same energy with the same wavelength.

Microfluidic device is a device that can be used for some operations on fluids and has at least one feature, wherein smallest dimension of said feature is 500 microns.

### BRIEF DESCRIPTION OF DRAWINGS

FIGS. 1A-D shows concepts of devices for extended storage of microfluidic volumes.

FIG. 2 shows concept of intake collector area that assists in accurate droplet disposition.

FIG. 3 illustrates principle of operation of microfluidic storage device.

FIG. 4 shows principle of restricted evaporation from microfluidic storage device.

FIG. 5A shows principle of operation of intake collector area.

FIG. 5B shows electrostatic targeting of intake collector area.

FIG. 6 shows multiway microfluidic storage and dispensing device.

FIG. 7 shows microfluidic dispenser for microcontact printing.

FIG. 8 illustrates principle of hydrophobic surface barrier.

FIG. 9 shows concentric single sided microfluidic dispenser for microcontact printing.

FIGS. 10-11 illustrates principle of operation of microfluidic dosing and dispensing device.

FIG. 12 shows vapor refill channel in microfluidic dosing and dispensing device.

FIG. 13 shows sequence of operation of microfluidic dosing device.

FIG. 14 shows microfluidic device for dispensing micro volumes to a surface.

FIGS. 15A-B shows principle of operation of to-surface dispensing microfluidic device.

FIG. 15C shows principle of operation of two barrier dosing and dispensing microfluidic device.

FIG. 16 shows multiway microfluidic reactor for N-by-M parallel reactions.

FIG. 17 shows two-sided microfluidic storage and dispensing device.

FIG. 18 shows evaporation stabilized microfluidic device.

FIG. 19 shows dispensing cycle of two-sided microfluidic dispenser.

FIG. 20 illustrates operation of surface microfluidic reactor.

FIG. 21 illustrates principle of operation of microfluidic reactor with self dosing capabilities.

FIG. 22 shows examples of surface microfluidic devices.

FIG. 23 shows mixed volume to surface microfluidic reactor.

FIG. 24 shows principle of chemical self-propulsion.

FIG. 25 illustrates principle of reverse phase chemical self-propulsion.

FIG. 26 illustrates principle of operation of microfluidic fluid discriminator device.

FIG. 27 shows fractal design strategy for multiway microfluidic liquid discrimination.

FIG. 28 shows schematic diagram of metastable microenvironment control device with electrostatic precipitation prevention.

FIG. 29 shows example of metastable microenvironment control apparatus.

FIG. 30 shows principle of creation of surface micro climate for microfluidic manipulations.

FIGS. 31-35 shows various layouts of designs for metastable microenvironment control device.

FIG. 36 shows example of fiber optical microfluidic manipulator apparatus.

FIG. 37 shows schematic diagram of thermo-optical coherent microfluidic manipulator.

### DETAILED DESCRIPTION

Nano-Scale Liquids Storage Apparatus

Apparatus has intake areas that exposed to the surface and have high affinity to the liquid it designed for. Intake area surrounded by surface which affinity to the liquid is lower then the one of the intake area. The intake area is adjacent to intake channel. Intake channel's surface has high affinity to the liquid and has one or more segments with narrow cross-section. Area of the segments is equal or less 10⁻⁸ m². Intake channel connects with storage cavity. Surface of the cavity has a continuous segment with high affinity to the liquid. Cross-section length of this segment has increases as it approaches dispensing channels. Dispensing channel may connect the cavity with a liquid dispensing apparatus. The dispensing channel has one or more segments with narrow cross-section which area is less or equal 10⁻¹⁰ m2, and is less than cross-section area of said intake channel. Surface of the dispensing channel has high affinity to the liquid.

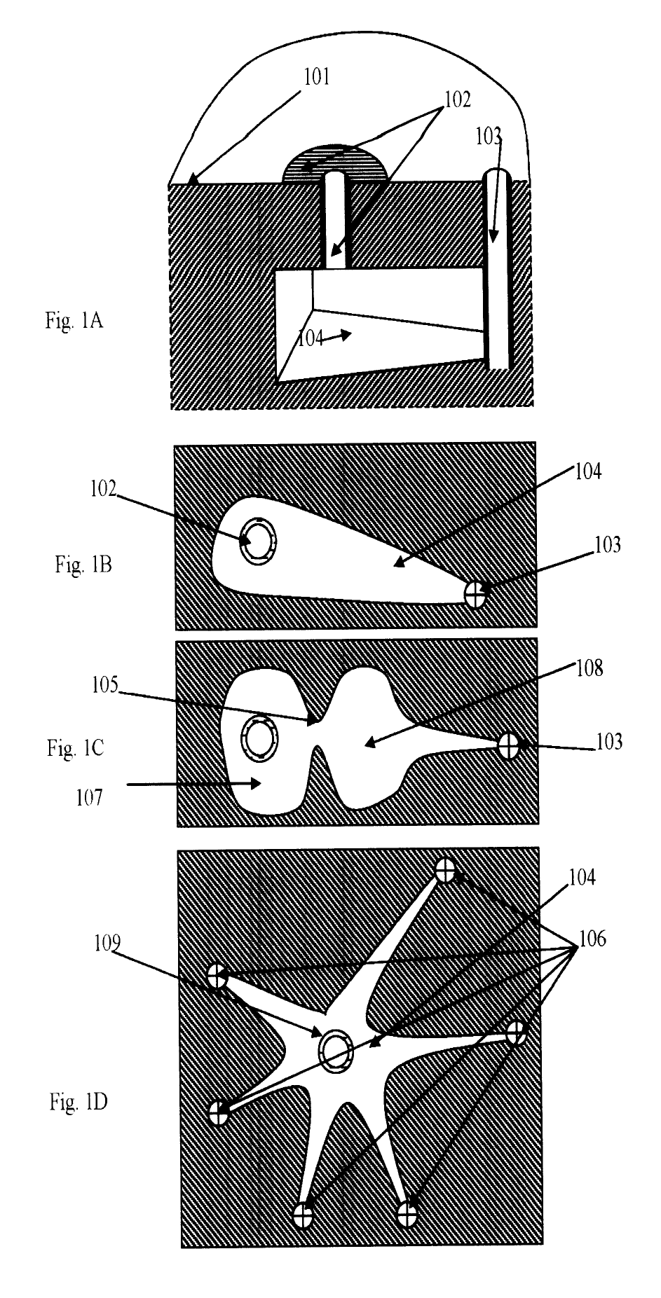

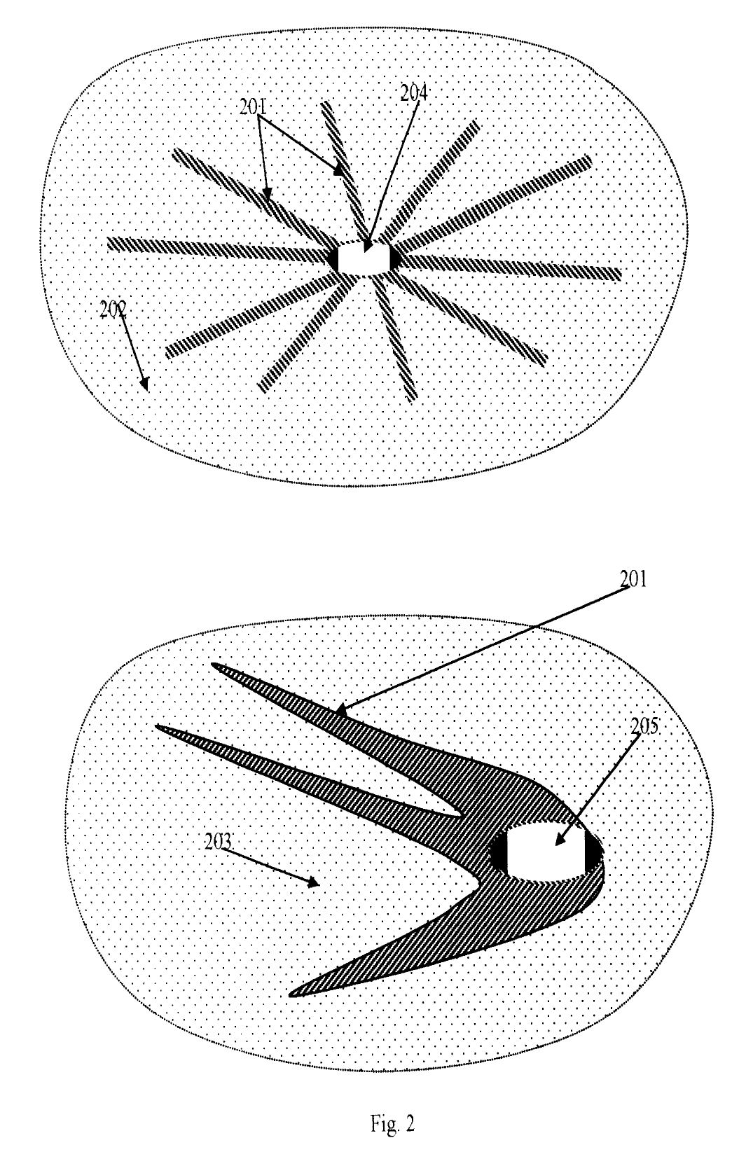

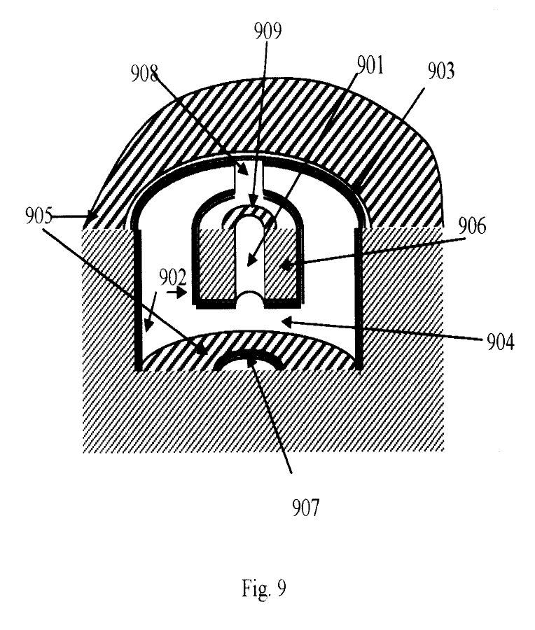

FIG. 1 and FIG. 9 show some example implementations of the described apparatus. On FIG. 1 the surface of the apparatus 101 has low affinity to the liquid volume it designed for. The surface at locations 102,103,104 has high affinity to the liquid. Element 102 forms the intake part of the apparatus. It connects the surface with internal cavity 104. The cavity 104 connects the intake part with dispensing cannel 103. The cross-section area of the cavity 104 decreases along the path between intake 102 and dispensing channel 103.

The intake part of the apparatus 102 (refer to FIG. 1B) is closer to larger cross-section part of the cavity 104, and the dispensing part 103 is located closer to smaller cross-section part of the cavity. Surface properties of said channels and cavities can be similar or dissimilar. As an example affinity to the liquid of at least one surface segment of said cavity 104 can be higher then one of intake channel 102, as well as different segment of surface of 102 can possess different surface properties. Cavity shape may have intermediate minimums 105 (refer to FIG. 1C) in its cross-section, but the dispensing part(s) 103,106 are located in areas of the cavity with cross-sections smaller than said intermediate minimums 105. The cavity of a complex shape has several chambers 107,108 separated by narrow channels 105. The apparatus can be implemented to have multiple dispensing parts 106 (refer to FIG. 1D) and single intake part 109. The dispensing parts 106 are located in narrow cross-section segments of the cavity 104.

Relative positions of the intake parts and the dispensing parts are not limited to examples shown in this document. Any relative placement of those parts that obey the initial rule of this embodiment will form the apparatus for nano-/micro-scale storage of liquids. FIG. 9 demonstrates an additional example of said apparatus implementation. In this example the dispensing part 901 placed inside the intake part 902,903. This arrangement has the intake part surrounding the dispensing part. The length of cavity 904 cross-section decrements along the pass from intake 903 to dispensing channel 901.

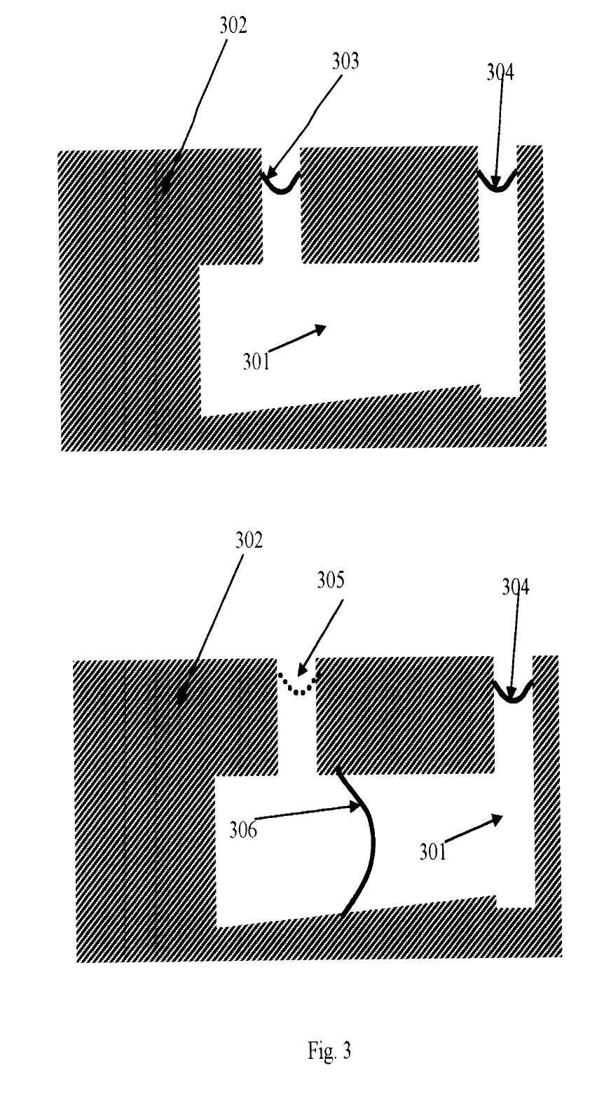

The properties of the surface around intake channel have important aspect on operations of the apparatus. FIG. 2 shows examples that assist in understanding the concept of the intake area of the apparatus. Intake area has surface with high affinity to the liquid volume 201, while the surface surrounding intake area 202,203 has lower affinity to the liquid volume it designed for. The intake channel opening 204,205 is located in area with high affinity to the liquid volume. The purpose of designing different intake areas is to assist the initial capture of the liquid volume when it is dispensed onto the surface in the vicinity of the intake part. The shapes and sizes of areas with high affinity to the liquid volume may vary, and it is possible to use apparatus that does not have surface elements with high affinity to the liquid volume that adjacent to the intake channel opening. This last case requires that the liquid volume be dispensed onto the surface in the way it immediately comes into contact with intake channel.

FIG. 3 demonstrates the dynamics of operation of the apparatus. Liquid 301 fills the cavity inside the body 302 of the apparatus. Meniscus 303 with negative curvature is formed in the intake channel. Meniscus 304 with negative curvature is formed in the dispensing channel. Small surface area of these meniscuses and their negative curvature reduce vapor pressure over the meniscuses that cause decrease in evaporation rate of the liquid's solvent.

Due to evaporation of the solvent the volume of the liquid 301 decreases and meniscus 303 moves from 305 position to 306 position while meniscus 304 still occupies dispensing channel. The position of meniscus 304 is maintained due to higher negative curvature of said meniscus 304 versus curvature of 303 or 306. The concentration of substances inside the liquid increases due to evaporation of the solvent, but the liquid remains continuously available for dispensing through the dispensing channel until all solvent evaporates.

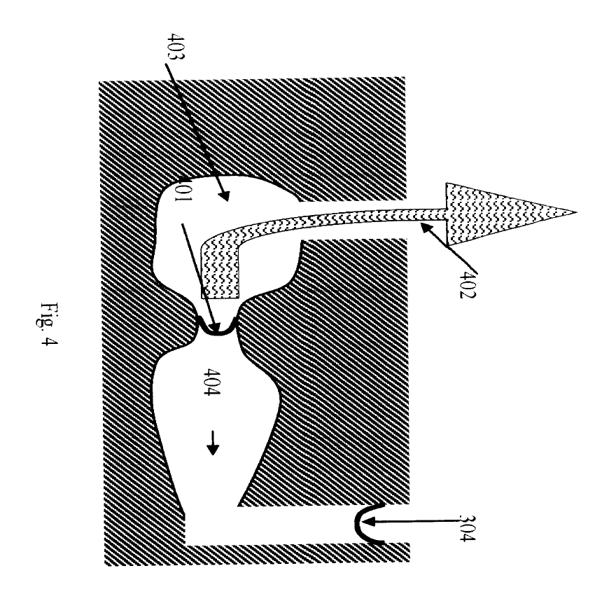

Special shape of the cavity with intermediate channels, as it was early described in this embodiment, allows significantly increase evaporation time for the solvent. FIG. 4 demonstrates principle of this design. Meniscus 401 inside the cavity will regain high negative curvature when it reaches the intermediate channel. This will reduce vapor pressure over the surface of meniscus. Due to longer way to the outer volume 402 diffusion rate of vapors will also be smaller. This will increase vapor pressure inside cavity 403. Combination of all these factors will significantly reduce the rate of evaporation through meniscus 401. This will allow maintaining liquid 404 in the apparatus for longer period of time.

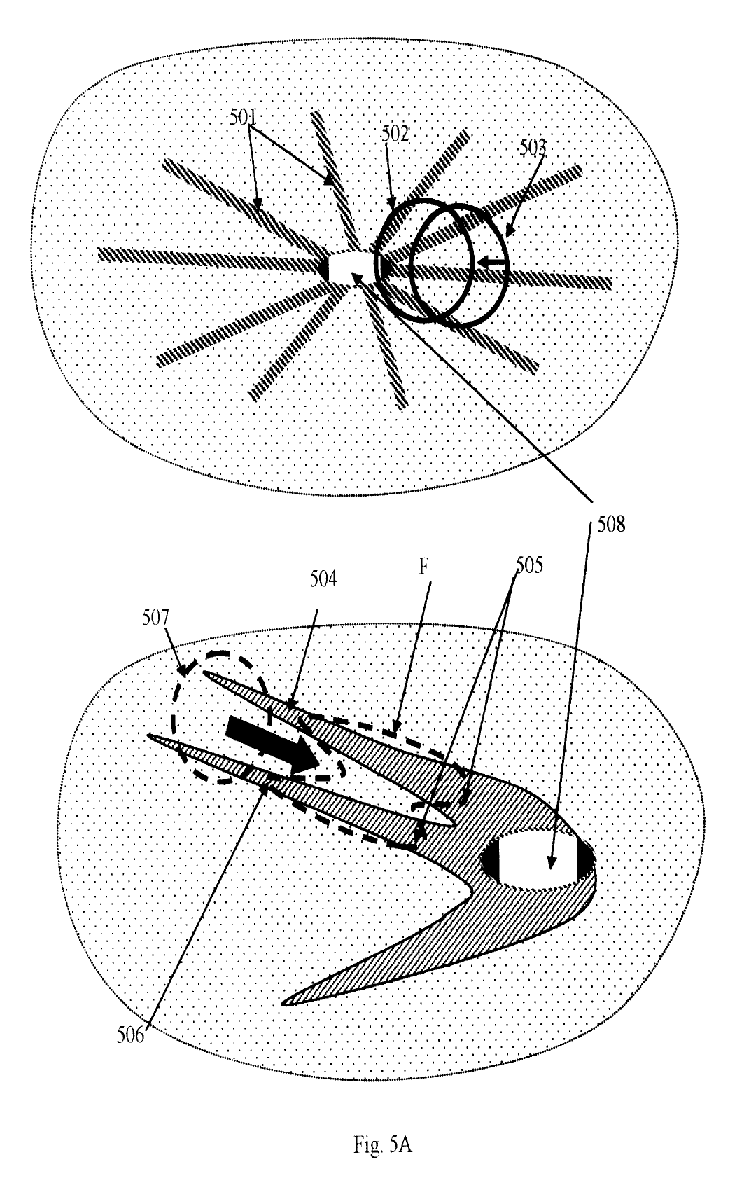

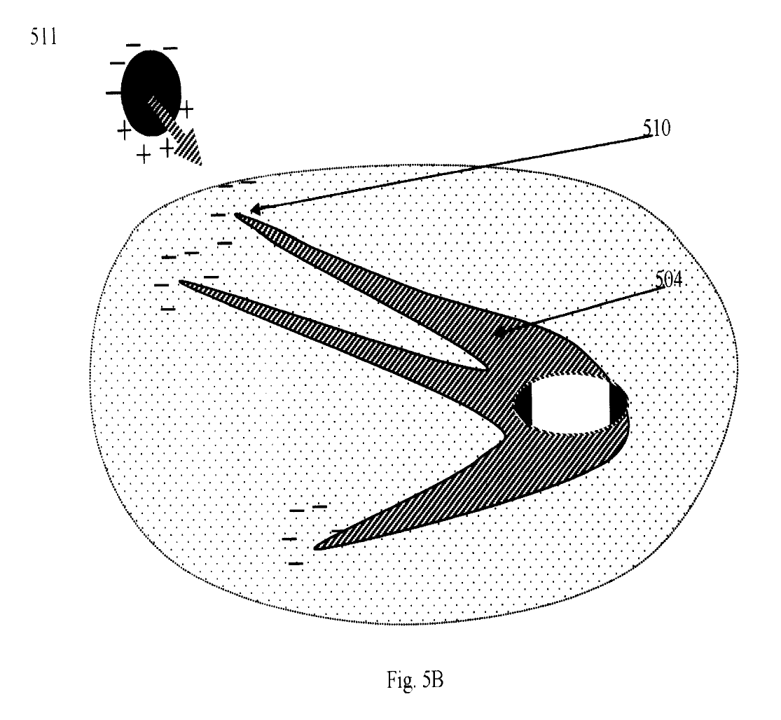

FIG. 5A demonstrates principles of operation of the intake area. Liquid volume on low affinity surface will take a shape with minimum surface area. In contact with high affinity surface segments 501 to achieve state with lower energy the area of contact with said segments will start to increase. Liquid volume in position 502 will have larger contact area with the segments 501 versus position 503. This causes liquid volume to move toward lower energy state. Material of the segments 501 and the bulk area are selected to have lowest dissociation energy with the liquid to reduce the barrier of energy required for liquid to maintain motion.

Similar principle works with pattern 504. Liquid occupies maximum area of high affinity segments 504 still maintaining minimum free surface. This causes liquid volume to migrate in the direction toward the intake channel. The length of contact lines 505 is larger than the length of contact lines 506. Moving force proportional to this difference causes the migration of the liquid volume from 507 position toward the intake channel 508.

This intake area apparatus allows increasing precision and stability of liquids deposition for small liquid volumes, especially when dispensing is performed using ballistic particles/droplets or other jet based techniques.

This approach can additionally be improved by supplying long-range electrostatic targeting of droplets toward intake area. The principle of said method illustrated on FIG. 5B. Construction of the intake area 504 can employ conductive or semiconductor materials with sufficient density of free carriers at predefined surface potential of the apparatus. Presence of free carriers will create excessive intensity of electric field at high curvature features 510 of the intake area. Droplet 511 may be oppositely charged or even have small electric charge of the same sign and sufficient kinetic energy to achieve the surface. In relative vicinity of features 510 the droplet is polarized and pulled toward the feature 510.

Intake area occupied by the droplet encounter redistribution of electric carriers and reduction or complete compensation of intense electric field at 510 locations. This prevents accidental capture of second droplet by the same intake area.

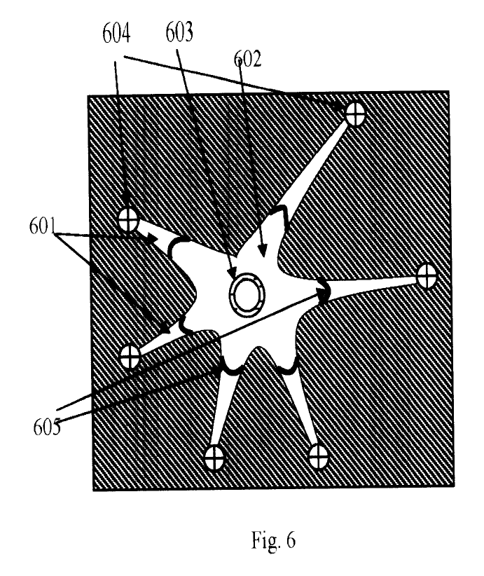

The storage apparatus with multiple dispensing parts is shown on FIG. 6. The liquid occupies space in segments 601 due to decreasing cross-section area of cavity 602 along the passes from the intake part 603 to the dispensing channels 604. Meniscuses 605 have negative curvature and this curvature increases in magnitude as volume of liquid 601 gets smaller. This in conjunction with increase of distances between the intake channel 603 and meniscuses 605 causes decrease in evaporation rate of the solvent. This implementation of the apparatus in addition to storage functionality provides flexible distribution function. The liquid may be dispensed through independent dispensing ports 604 with minimum possibility of cross contamination.

### EXAMPLE 1

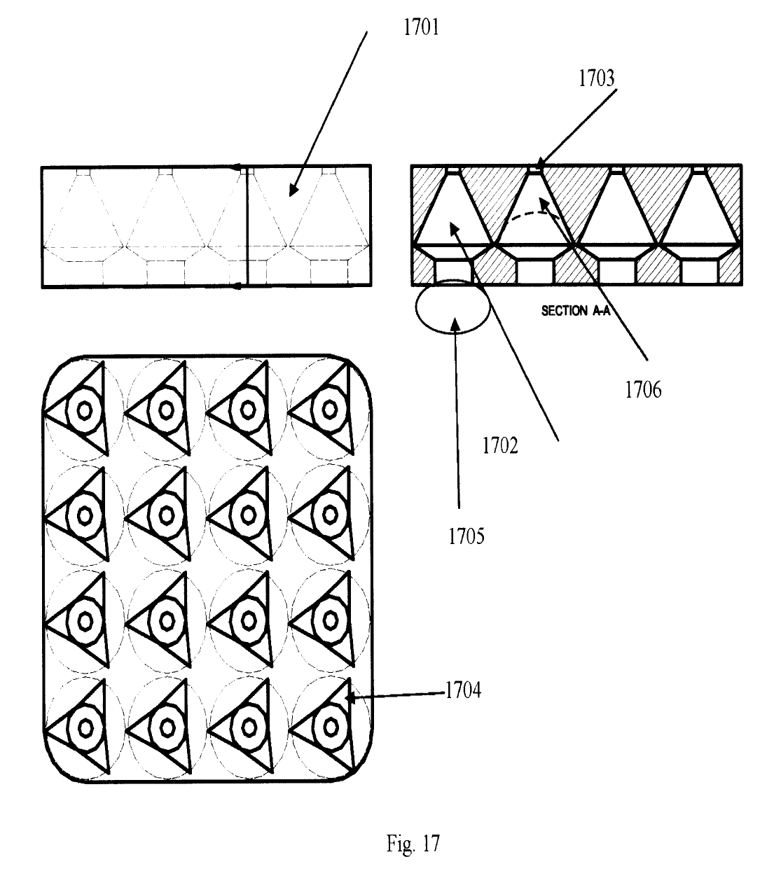

FIG. 17 illustrates design of microfluidic storage device that employs use of two opposite side of a surface. The body 1701 of the device manufactured from layer of Pyrex glass with 8192×8192 micromachined cavities 1702 (only some are shown on illustration) with volume 2 picoliter and period of 5 micrometers. Each cavity has etched dispense channel 1703 with diameter 0.25 micrometers. Opposite surface has photolithographically produced intake areas created by passivation of unmasked area with fluorinated ethylenepropylene. Dispensing side of the device is also passivated with similar hydrophobic layer.

The device is filled with aqueous solutions by means of deposition of 1 picoliter droplets 1705 that are pulled inside cavities 1702 by means of capillary forces regardless of physical orientation of said deposition equipment and the device. Liquid occupies space 1706 that adjacent to dispensing channel 1703. At the end of deposition process intake surface of the device sealed by pressure sensitive polymer film that establish physical barrier for vapor diffusion and particle contamination of disposed liquids.

In described state at 50% relative air humidity and temperature 293 K dry out time for the array in assumption of absence of forced air circulation is approximately two hours.

### EXAMPLE 2

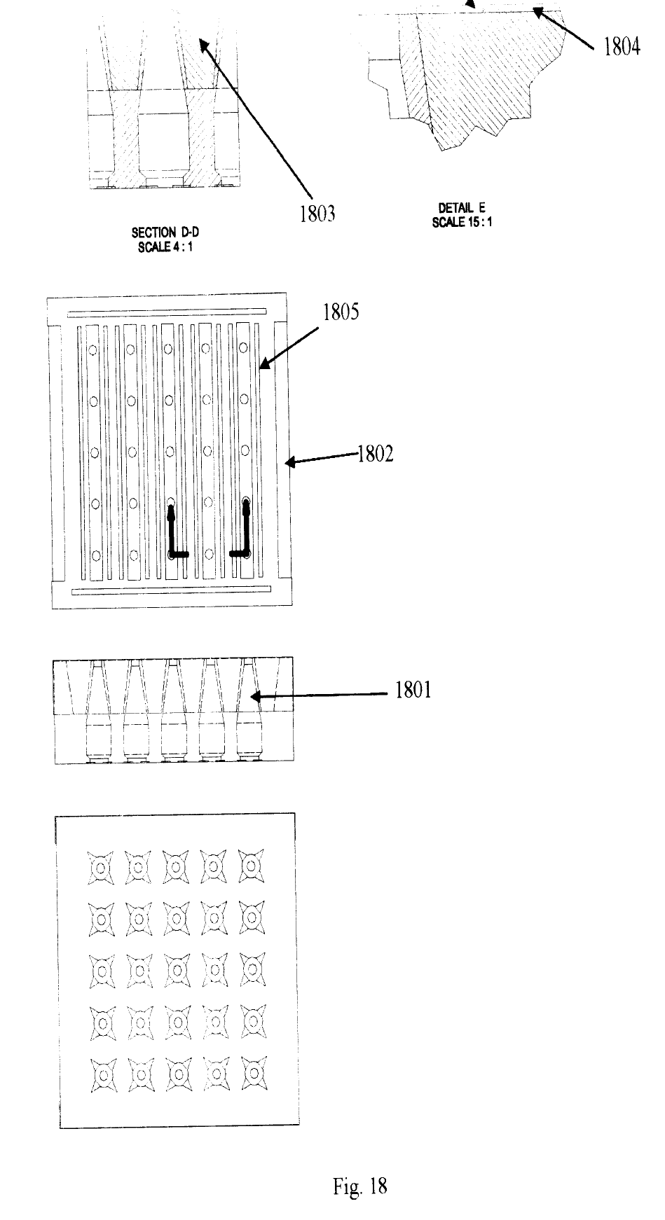

FIG. 18 illustrates yet another design of microfluidic storage device that employs array of microfluidic storage devices. This array manufactured using process described in previous example. On dispensing surface of the plate plurality of groves were created using etching or micromachining processes. These groves then filled with porous hydrophilic material 1803 (silicon oxide in this example). On top of this thin layer of hydrophobic material 1804 (sputtering of aluminum can be used) was deposited using photo mask to preserve plurality of open segments 1805.

Operation of this device are identical to one described in the previous example, except that volume of porous material 1803 is saturated with water. This design creates artificial area with high vapor pressure around open ports and contains significant supply of liquid solvent. In this example total volume of adsorbed water is 1 milliliter, and dry out time for the array is increased to 36 hours.

This storage extension is possible because curvature of solvent on porous regions is smaller than one of dispensing ports, which creates excessive vapor pressure preventing solvent to evaporate through open dispensing ports.

The devices disclosed in this embodiment can be used in plurality of commercial applications. Here are some examples: i) Refill cartridges for micro- and nano-scale arrays of stamps. Where each stamp may have identical or different shape and said shape can be as simple as single ball or needle, and said stamps can be solid or elastomeric, and can be mounted on single substrate or array of cantilever type devices.

ii) Cartridge of analytes, reagents, ligands, etc. Where said cartridge can be disposed on surface of another microfluidic device.

### EXAMPLE 3

This example describes devices identical to ones disclosed in previous two examples with one exceptional feature. These devices do not contain dedicated intake port, but rather singe port and intake area surrounding it. Materials and manufacturing process for these devices remain unchanged from previous two samples, but method of their use changes.

Said devices are disposed in atmosphere of helium and special steps could be taken to desorb residual gases or other weekly adsorbed liquids from devices. Liquid is then disposed on available ports and device is removed from helium environment.

Considering dimensions of the example 1, helium diffuses away from said cavity and liquid is completely pooled inside the cavity in less then 15 seconds.

Micro-Contact Liquid Dispenser

Apparatus has a flat planar surface with several channels. At least one channel has a cross-section area distinct from others. Channels are connected inside the body of the apparatus. Said channels contain liquids for dispensing, and at least two ports exposed to parallel surfaces.

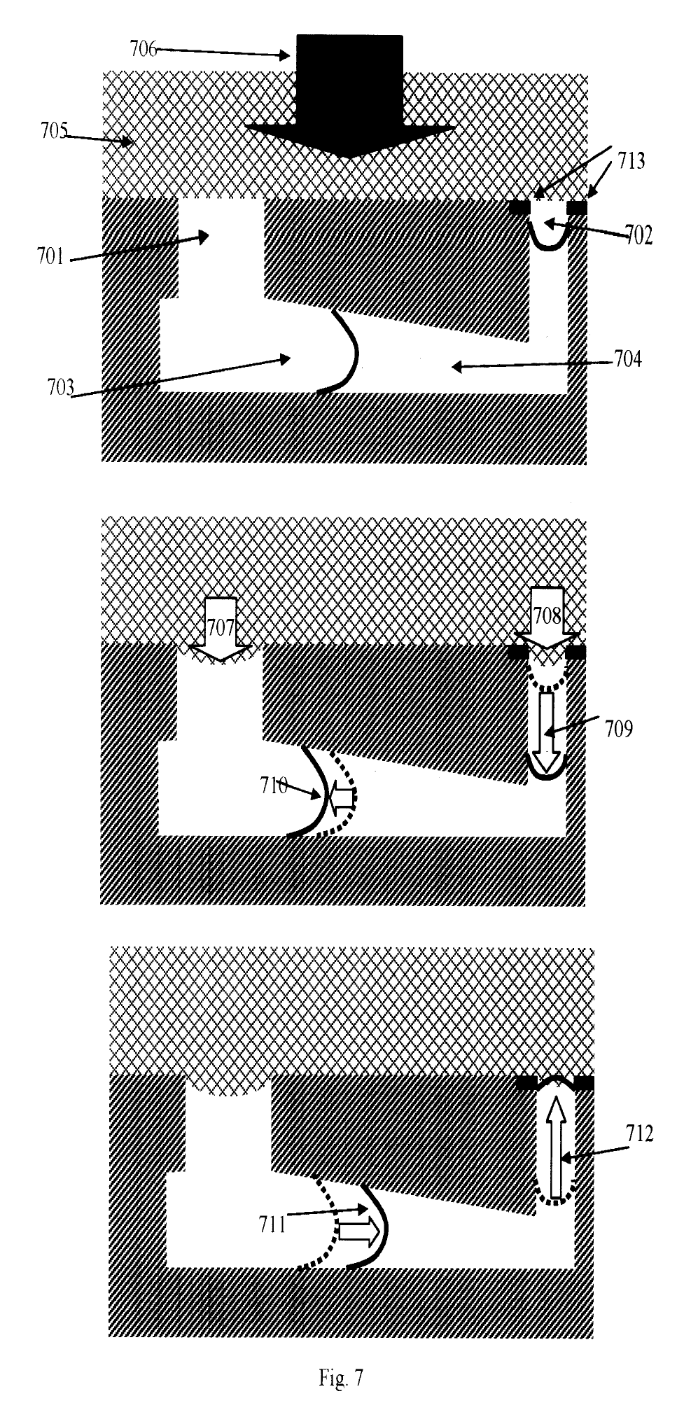

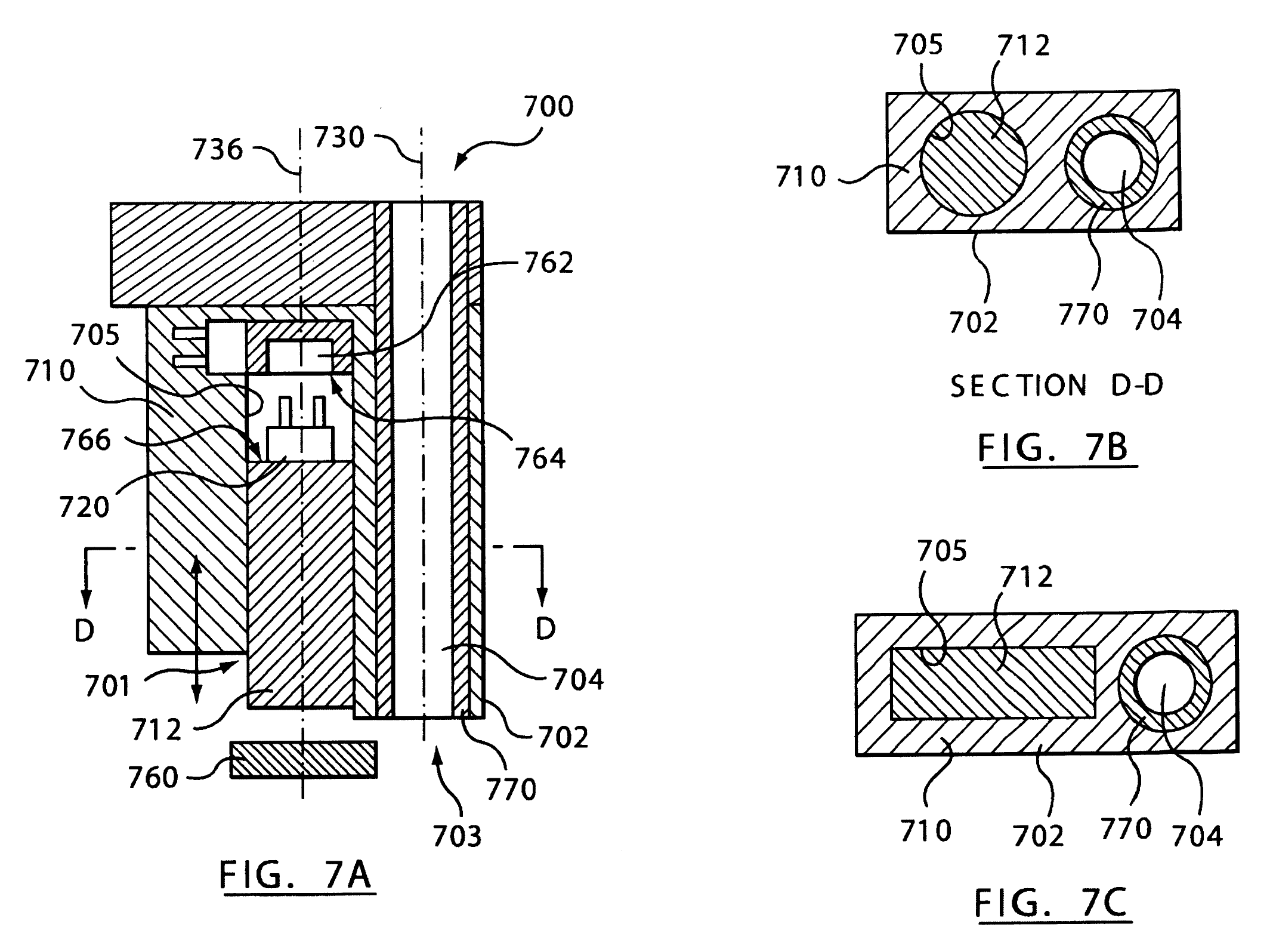

The apparatus is designed for high precision deposition of liquids onto surfaces of elastic or deformable materials. Nevertheless same apparatus can be used in applications with rigid stamps. FIG. 7 demonstrates operations of the apparatus with two channels. This however does not limit the invention, since same principle is applicable to devices with multiple channels. Two cannels are selected only to simplify the idea's description. Apparatus has two channels 701 and 702 exposed to the surface of the body. Cross-section area of the channel 701 is larger than one of channel 702. Surprisingly this apparatus operates counter the law of static hydraulics. Channels 701 and 702 are connected with cavity 703. Part of the cavity is filled with liquid 704. Another part of the cavity is partially empty. At least some surfaces of the cavity and the channels are made to have high affinity to the liquid. Liquid completely fills channel 702, and channel 701 may become empty when volume of the liquid becomes insufficient to fill them both. This behavior is caused by forces of surface tension due to smaller area of cross-section of channel 702.

On top of the body of apparatus a flat substrate 705 is shown. It represents stamp for microcontact printing because in current example exact shape of said stamp is not important. Some uniform pressure 706 is rapidly applied on the substrate toward the apparatus. This pressure causes deformations 707 and 708 of the substrate. Initial buildup of gas pressure is higher in channel 702 due to smaller free volume in this channel. This causes liquid from channel 702 to recess into the cavity 709. The ratio of channel perimeter to its area is higher for channel 702, and total volume of gas in channel 702 is smaller than displaced volume 707 in channel 701. All said factors plus the roughness of the surfaces of the apparatus and the substrate cause gas from channel 702 quickly diffuses into the liquid and into an outside volumes. Another factor to consider is adiabatic behavior of said gas. Rapid increase in pressure of channel 702 causes temperature increase of said gas, and due to high surface to volume ratio of said gas temperature decreases in channel 702 much quicker that in channel 701, which in turn causes liquid in cavity 703 to oscillate. Excessive pressure in channel 701 causes meniscus's 710 shift to 711 position, and causes meniscus 712 rise to the top of channel 702. This causes liquid to be deposited on said substrate in the location of channel 702.

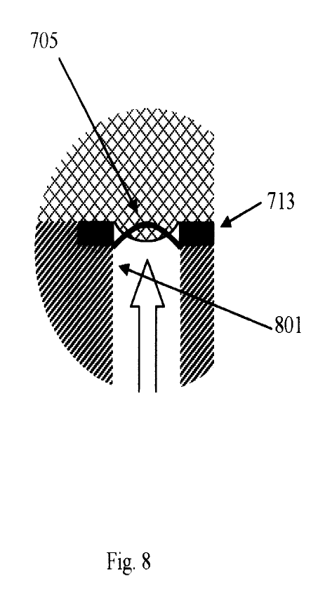

Accuracy of operations of this apparatus can be increased with introduction of low affinity barrier 713 on top of channel 702, where in said barrier can also be formed as low affinity monolayer surrounding port 702. FIG. 8 shows principles of operation of said barrier. The barrier prevents accidental contacts between liquid and the substrate. Because the rest of the channel's surface has high affinity to the liquid, it causes the meniscus to have negative curvature and the edges of the meniscus stops on the edge of barrier 713. Excessive pressure 801 from another channel causes liquid to move toward substrate 705, which causes meniscus become positively curved, and produce counter pressure that prevents further motion of the liquid. The meniscus comes in contact with the substrate 705 in much smaller area. This area also sealed from the rest of substrate's surface by the contact with barrier 713.

FIG. 9 shows implementation of said apparatus in one of many possible shapes. This implementation has two channels enclosed in each other. Wide channel 902 surrounds the narrow channel 901. Channel 902 has the intake area 903 that simplifies deposition of liquid into the apparatus. Surfaces of channel 902, both external and internal, have high affinity to the liquid. The top surfaces of the apparatus and bottom of the cavity 905 have low affinity to the liquid. All surfaces of central part 906 have high affinity to the liquid. Central area 907 in the cavity has high affinity to the liquid. Bridge elements 908 hold elements of the apparatus together. Surface of the narrow channel 901 has high affinity to the liquid. Barrier 909 has low affinity to the liquid.

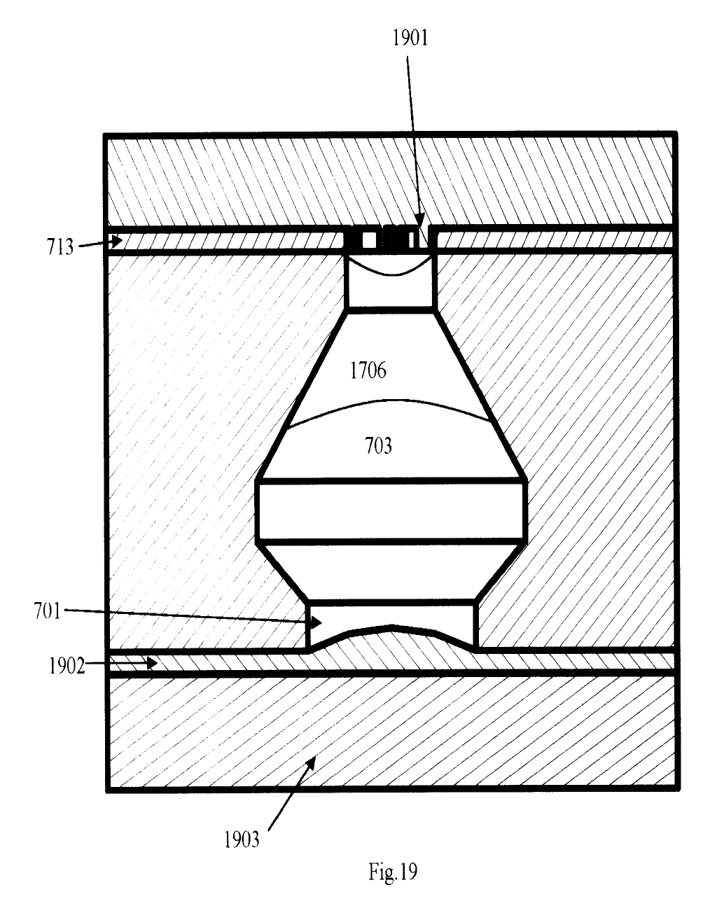

Devices disclosed in examples 1 and 2 and shown on FIGS. 17 and 18 are also suitable for use in disclosed deposition method. FIG. 19 illustrates application of those devices to perform controlled deposition of liquid substances onto rigid stamp 1901. Camber 703 contains liquid 1706. Second port 701 interfaces with porous polymer filter film 1902, and said filter interfaces elastic support base 1903. Rapid increase in pressure applied to the stamp causes deformation of elastic base 1903 and pressurizes volume of cavity 703, which in turn causes deposition of said liquid 1706 onto stamp 1901. Reduction of said pressure allows gaseous phase to penetrate said filter and prepare the device to next operating cycle.

Amount of deposited liquids in disclosed methods is controlled by means of controlling applied force and rate of increase of said force.

Micro-Through Atto-Liter Scale Liquids Dispensing Apparatus

Device comprises of primary channel, and said channel contains surface segment with low affinity to a liquid, where in said liquid be supplied by said primary channel, and there is second channel or cavity that has opening to said primary channel and said opening is in direct vicinity of said low affinity surface segment, and said channel may have one or both ends exposed to a surface.

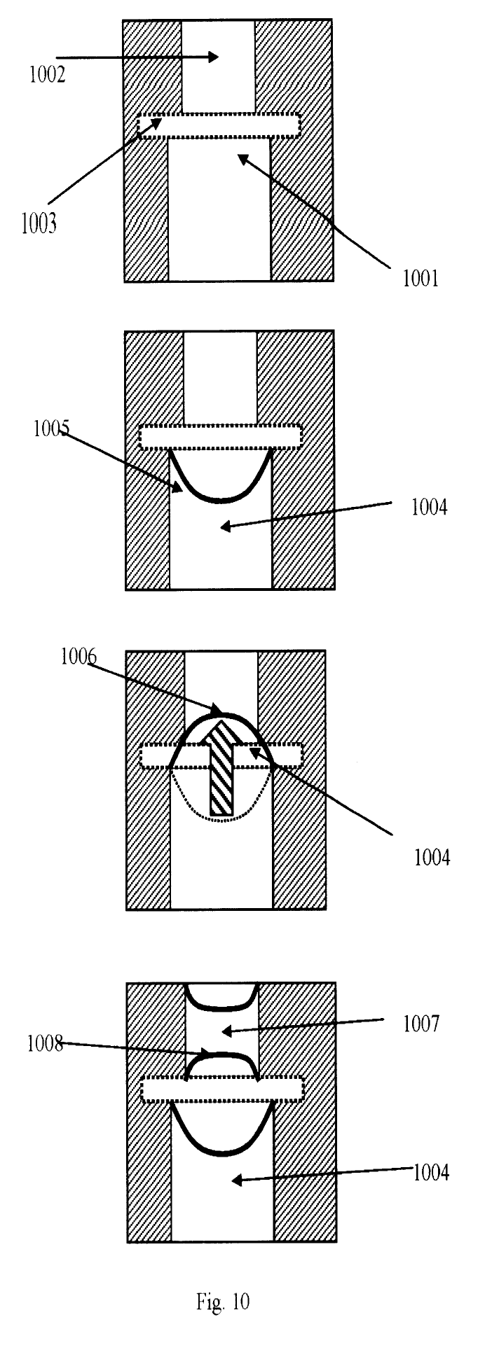

One of possible implementation of this apparatus is shown on FIG. 10. The liquid source supplies fluid by channel 1001. It is separated from the dispensing part of channel 1002 by cavity 1003. The surface of dispensing part 1002 has high affinity to the liquid. Cavity 1003 forms an energy gap between parts 1001 and 1002. Surface fragments of this cavity that may come in contact with the liquid have low affinity to said liquid. Surface of channel 1001 have higher affinity to the liquid than those surface fragments.

Liquid 1004 may occupy complete volume of the channel 1001, and form meniscus 1005 on interface with cavity 1003. During dispensing process extra volume of liquid is introduced into the channel 1001. This external pressure causes the meniscus to move into position 1006. Contact interaction of the meniscus with surface of part 1002 causes liquid to occupy some volume 1007 of the part 1002. At the end of this dispensing operation liquid in part 1001 will recess to near its original location, and channel part 1002 will have some volume of the liquid.

Process of separation of liquid onto fragments is associated with initial increase in pressure of gaseous phase in cavity 1003 during formation of meniscus 1006, and sequential drop in said pressure during formation of meniscus 1008 and expansion of said gaseous phase. This pressure drop causes increase in partial pressure of vapors of said liquid in said gaseous phase abs well as diffusion of gases absorbed in said liquid into said gaseous phase. These two factors increase pressure in said cavity 1003 and prevent merger of said separated liquid volumes without incremental increase of pressure in channel part 1001. Liquid volume of segment 1007 is defined by viscosity and surface tension of said liquid as well as volume of cavity 1003.

If part of channel 1002 has minute volume that further defined by second energy barrier, where in said barrier can be formed by second downstream surface area with low affinity to said liquid or any geometrical barrier like increase in crossection area, then said minute volume can be completely filled in prior to formation of meniscus 1008 completed.

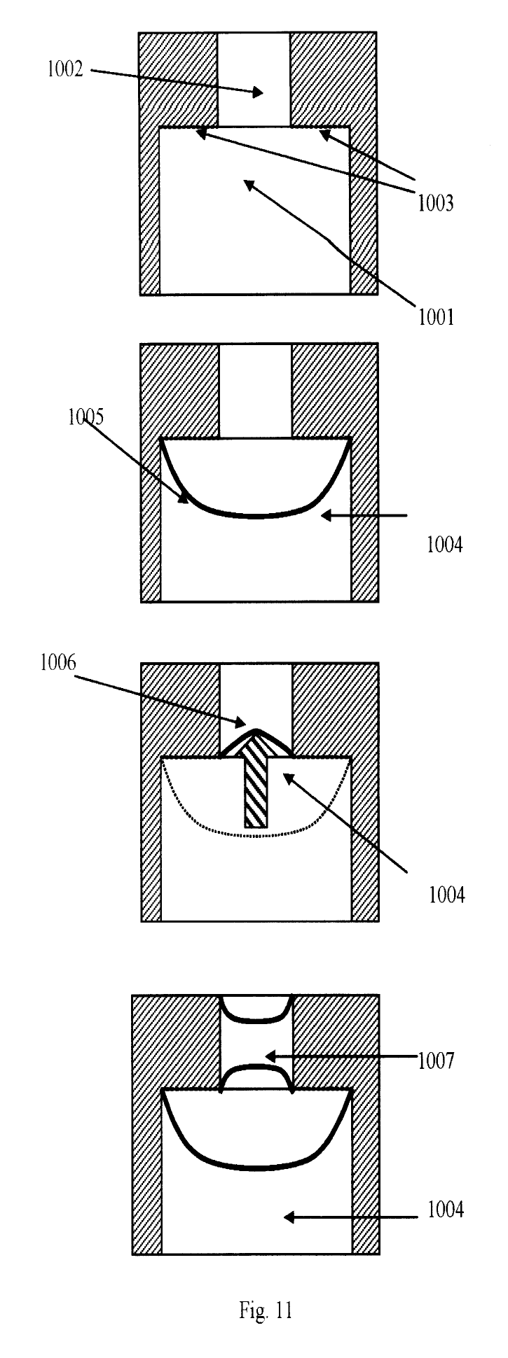

FIG. 11 shows another implementation of the apparatus. This implementation does not have low affinity cavity like the previous design. It replaces said cavity with the surface segment 1003 that has low affinity to the liquid and separates the surfaces of dispensing channel part 1002 from intake part 1001. Prior to dispensing operation the liquid 1004 may occupy the channel 1001. The meniscus 1005 is out of contact with the surface of channel part 1002. During dispensing operation liquid pressure in channel 1001 increases and meniscus 1006 comes into contact with surface of the channel part 1002. This causes liquid to occupy the volume of channel part 1002. At the end of this dispensing operation liquid in channel 1001 will recesses to near its original location, and channel 1002 will have micro volume of the liquid 1007.

Two examples described here in illustrate principle of operation of dispensing device when there is a need to separate single micro volume at a time. The second energy barrier in these implementation is lower that previous upstream barrier, that simplifies following use of said micro volume. Said devices most efficiently employed at low pressure microfluidic systems, when contribution of reduced pressure of cavity 1003 has minimal impact on magnitude of second energy barrier.

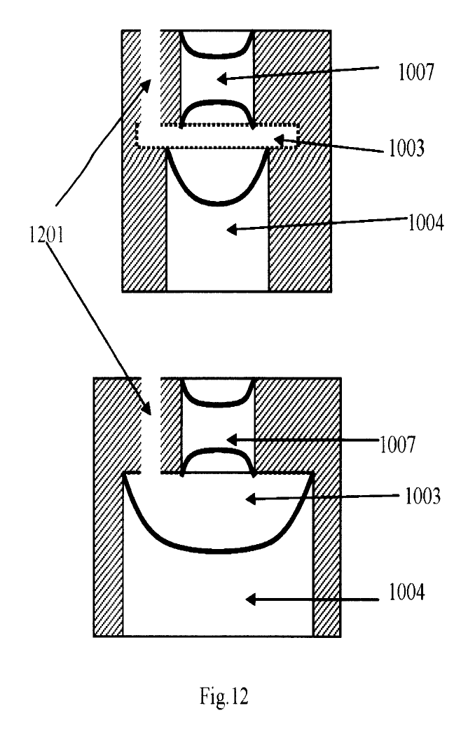

Same principle can be easily applied to high pressure microfluidic devices. The cavity or low affinity gap 1103 in this apparatus may be connected with large cavity and/or external pressure source, and/or external volume. FIG. 12 shows some example of this design. Connecting channel 1201 allows controlling gas pressure in the gap between stored liquid 1004 and dispensed liquid volume 1007.

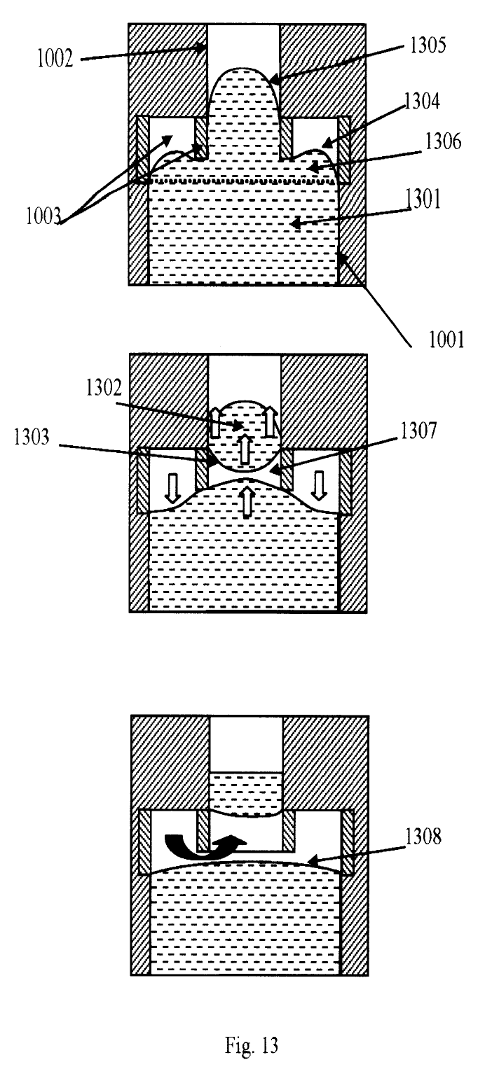

This apparatus can be implemented using energy gap formed by gas or vapor phase volume. Various geometrical implementations of such gap can be implemented. FIG. 13 shows an example of one of such implementations. The surfaces of both dispensing channel part 1002 and supply channel part 1001 have high affinity to the liquid. The low affinity gap is formed by volume 1003 that is occupied by liquid's vapor or other gases.

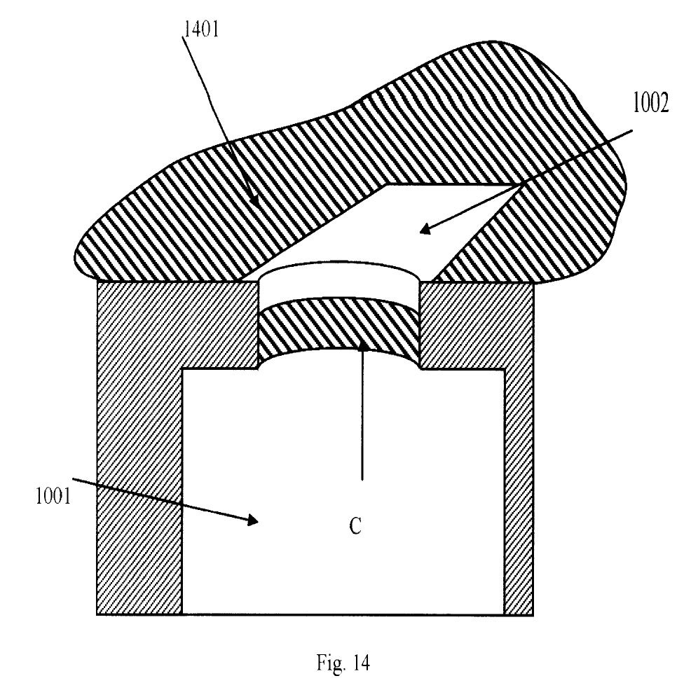

The apparatus allows implementing dispensing part as a segment of surface. FIG. 14 shows an example of such implementation. The dispensing part 1002 exposed to the surface, where in said surface may represent surface of the device body, surface of another channel or cavity. It is surrounded by surface segments 1401 with lower affinity to the liquid. The low affinity gap 1003 separates the dispensing part 1002 from supply part 1001.

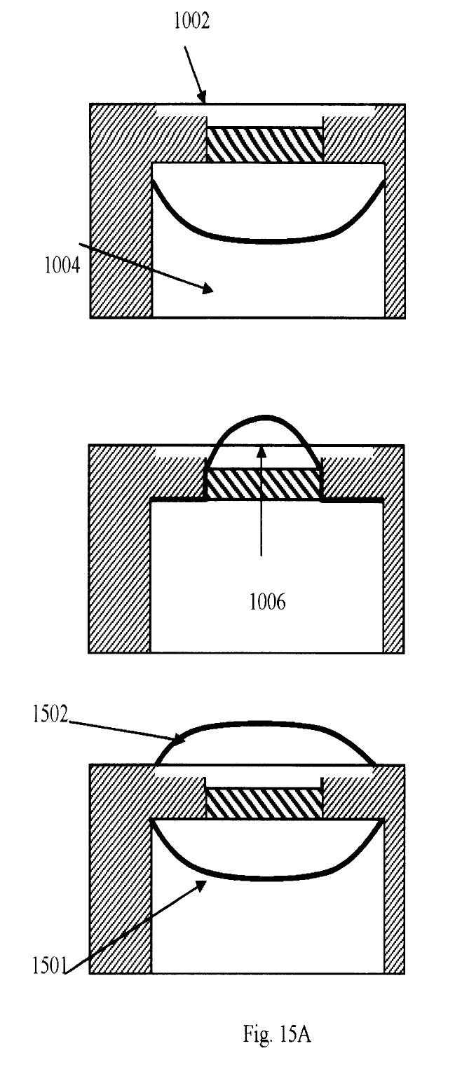

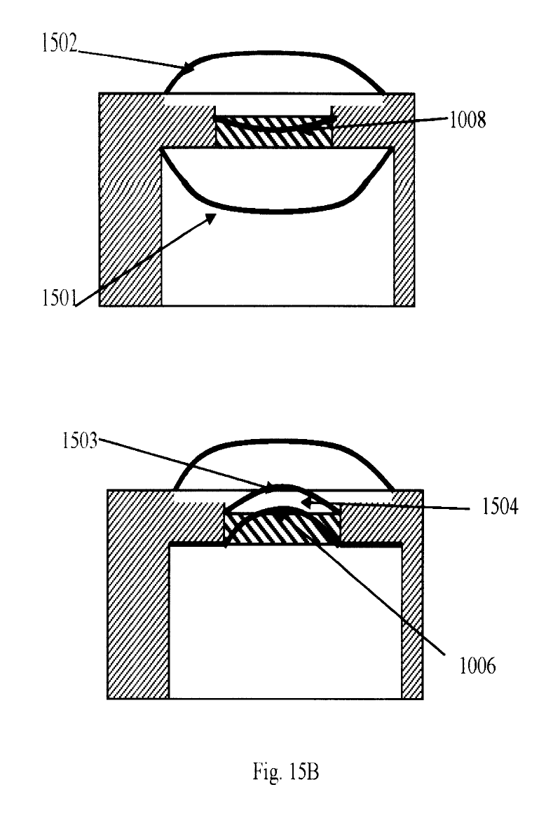

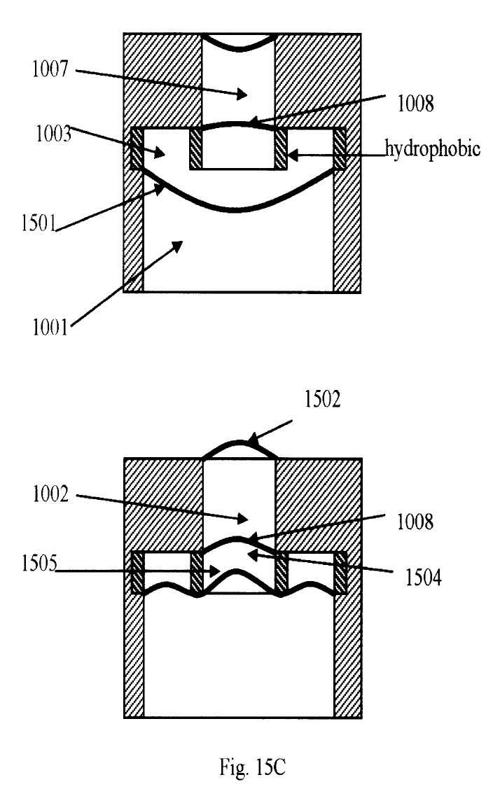

FIG. 15A shows the dynamics of operation of this apparatus's design. During said dispensing operation the liquid in storage part 1004 moves toward the dispensing part 1002. This causes the meniscus 1006 to contact high affinity surface of the dispensing part 1002. This causes the liquid to occupy surface of the dispensing part 1002. At the end of dispensing operation liquid in storage part recesses to near its original location 1501, and the dispensing part have surface covered with micro volume of said liquid 1502.

All devices previously disclosed in current embodiment operate in the same functional cycle that comprises i) disposition of liquid into intake part 1001 of primary channel at pressure P₀ that can be lower or equal P_{b} pressure that is required for overcame energy barrier 1003 by forming meniscus 1006, ii) formation of meniscus 1008 restores energy barrier and stops liquid transition to dispensing part 1002, where in said transition is blocked unless intake pressure Pₒ further increases to overcome sum of energies of said first and second energy barriers together, or liquid is removed from dispensing part 1002. FIG. 15B illustrates this cycle. Said separation of liquid forms meniscuses 1501, 1502, and 1008. As pressure in the intake part restores to P_{b} level meniscus 1502 moves into position 1006. Excessive vapors and desorbed gases create padding between meniscuses 1501 and 1008 that causes meniscus 1008 move to position 1503, which also causes curvature increase of meniscus 1502. Deformations of 1008 and 1502 create additional pressure P_{d} that has to be added to intake pressure to cause merger of meniscuses 1501 and 1008.

Said differential pressure P_{d} can be further increased by allowing part of gaseous phase from cavity 1003 into padding 1504. FIG. 15C illustrates this design concept. Initial application of P_{b} pressure to intake part 1001 caused said separation of micro volume 1007 and recess of liquid meniscus to 1501 position. gas form cavity 1003 reclaims volume beneath meniscus 1008. Advance of liquid from intake part 1001 causes meniscus 1501 shift to 1505 position that separated by gas padding 1504 from meniscus 1008. Padding 1504 causes deformation of meniscuses 1502 and 1008, which creates significant pressure P_{d}. Said pressure counteracts intake pressure and prevents further motion of said liquid.

Advantage of methods and devices disclosed in present embodiment also comprises isochoric dispension of said liquid. Since no additional source of gas or other immiscible liquid is required the total volume of fluids downstream from said device increases only by minute volume of dispensed liquid. All prior art microfluidic devices for separation of minute volumes required introduction of immiscible fluid or gas from dedicated gas source.

### EXAMPLE 4

Device on FIG. 13 has polystyrene walls (contact angle 840) 1001 and 1002. Cavity 1003 has FEP walls (contact angle 1110). Diameter of part 1001 is 0.4 micrometer and diameter of part 1002 is 0.2 micrometer. Thickness of cavity 1003 is 0.2 micrometer in the center and 0.25 micrometer total. Gas pressure in volume 1002 is 10 KPa. Liquid 1301 is water at temperature 300 K.

Differential pressure required for liquid to pass cavity 1003 is 0.5 MPa. This pressure creates meniscus 1304 with curvature radius 1.9 microns and meniscus 1305 with curvature radius 0.28 microns. Formation of micro droplet 1302 allocates 3.4 attoliters and has 14.5 microns curvature radius of lower surface 1303. This significant reduction of pressure in volume 1307 causes redistribution of liquid from area 1306 that results in formation of meniscus 1308.

### EXAMPLE 5

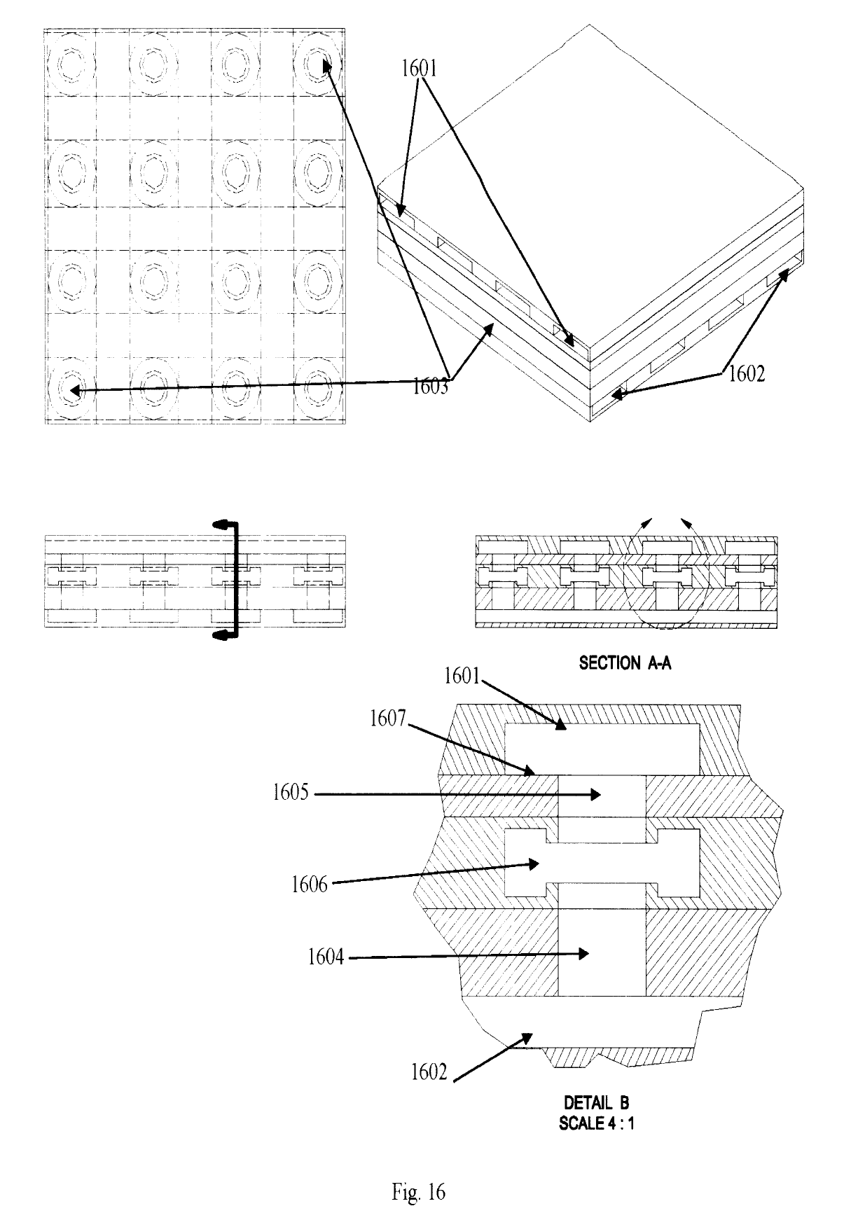

FIG. 16 shows segment of microfluidic device that implements method and principle of devices disclosed in the current embodiment. Segment comprises two layer of parallel channels 1601 and 1602 oriented in crossing direction that allows N×M combinations in case experiment is conducted using N samples and M ligands. N×M array of said devices 1603 disposed between said layers in a way that device in row n and column m has liquid connections with channels m and channel n respectively. Each device comprises intake 1604 and dispensing 1605 cavities separated by hydrophobic cavity 1606. Outer surface of dispensing cavity and surfaces of analyte channels 1601 are covered with stable layer of hydrophobic material.

Each intake channel receives specific ligand solution that pressurized to pressure P₀ that is below pressure level required to break energy barrier of cavity 1606. Each analyte cavity receives train of micro droplets of analyte in a way that distance between droplets matches the period of array along analyte channels 1601, and train contains at least M droplets. This results in N×M droplets of analyte. Said droplets travel along channels 1601 with either predefined speed or over predefined distance, which guarantee that each droplet at specific time moment be positioned between dispensing ports. Said event is synchronized with pressure source controlling ligand's channels 1602 and pressure increased to P_{b} level that provides simultaneous transfer of ligands into all dispensing ports. Continuation of motion of analyte droplets causes mixing of said droplets with appropriate micro volume of ligand. To prevent sequential refill of dispensing channel pressure on channels 1602 can be reduced to initial value.

Result of described experiment is array of N×M micro droplets of N×M combinations between N analyte samples and M ligands. This array was created in single step that allows further parallel analysis of produced chemical reactions. It is also possible to perform operations dispensing one ligand at a time.

Surface Reactor

Apparatus has a surface segment with some affinity to a liquid. Reactor section has an energy gap that represent energy barrier for said liquid. Said gap is ether segment of surface with lower affinity to the liquid or geometrical feature of the substrate's surface. Next to the gap there is a fragment of the surface with higher or equal affinity to a liquid product. The gap is adjacent to or is a part of another apparatus aimed to be able delivering second compound for the reaction with the first liquid compound that form said product.

All examples of the present embodiment assume that liquids interface vapors of similar composition and said interfaces are in equilibrium states.

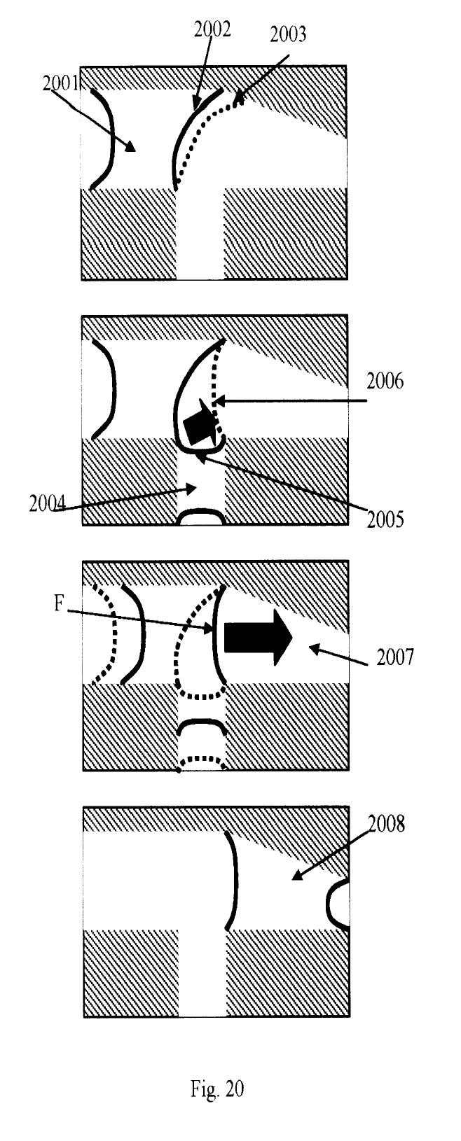

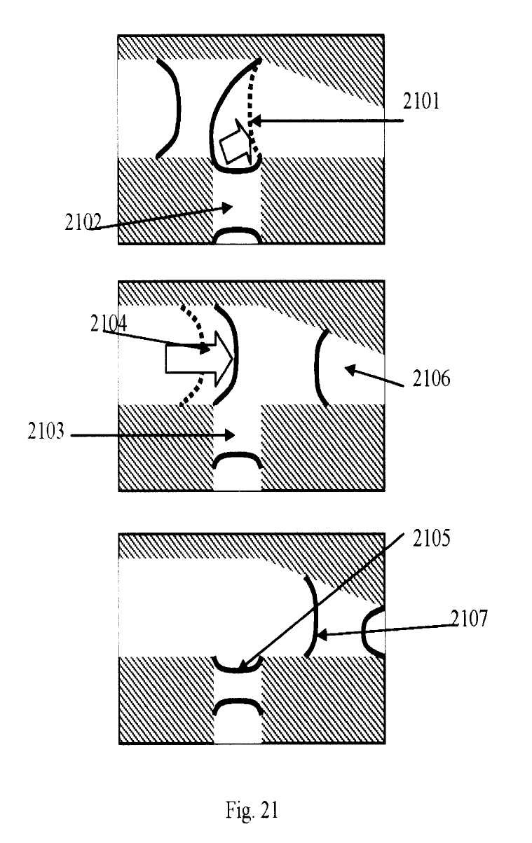

FIG. 20 helps to understand principle of operations of this apparatus. First reagent enters the apparatus through guide 2001. Its meniscus reaches position 2002. Its further motion is limited. Motion of the meniscus to position 2003 will cause increase in surface free energy. Second reagent enters the apparatus through guide 2004. If first reagent is not present in described location then meniscus of the second reagent will be at position 2005. When both reagents are present their meniscus positions become unstable. This causes their meniscus to join and move liquid to new intermediate location 2005 with decrease of total surface free energy. Exit guide 2007 has higher affinity to the liquid product or smaller cross-section or any other factors that reduces surface free energy of the liquid product when it moves to a new position 2008.

It is possible to consider all combinations of cases when different amount of reagents are supplied for this apparatus in conjunction with capacity and shape of its exit channel. To make this consideration more concise only some principal cases are discussed below.

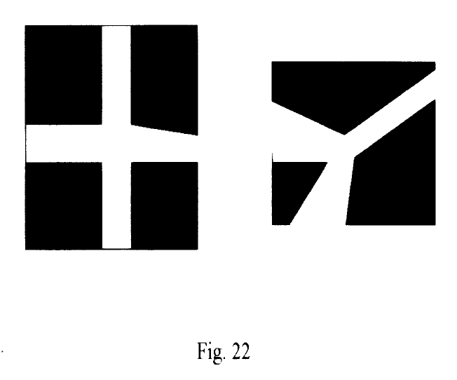

Cross-section of one of the reagent guide is significantly smaller than the others. This case is illustrated on FIG. 22. After the merger of meniscuses of the reagents the meniscus 2101 pulls both reagents and the product toward the exit guide. If surface affinity of guide 2102 is low it will allow the complete volume of reagent 2103 to be sucked into the exit guide prior the moment guide 2104 is empty. Otherwise factors of viscosity of reagent 2103 and low surface free energy of meniscus 2105 cause formation of said meniscus 2105 energetically favorable. 2105 is formed when complete volume of first reagent 2104 transferred to exit guide 2106. Because surface free energy of meniscus 2105 is small it allows flow of reagent from channel 2104 to 2107 position. This will result in partial consumption of reagent from said second guide.

Apparatus design allows implementations with more than two reagent channels. These implementations can be based on the principle described in this embodiment. Alternatively the same functionality can be achieved by sequential connections of two-reagent apparatuses.

FIG. 22 shows various examples of implementations of the apparatus. It is not intended to limit the invention to these particular configurations and provided for demonstration only. FIG. 22 shows top view on surface of devices. Bodies of the devices are made from Acetal (shown white) and guides are formed by mask of FEP created using photolithography (shown black). Approximate width of the guides is 5 micrometers. Shown devices are capable of handling micro volumes above 30 femptoliters. Reducing average size to 0.5 micron allows manipulation of volumes above 30 attoliters.

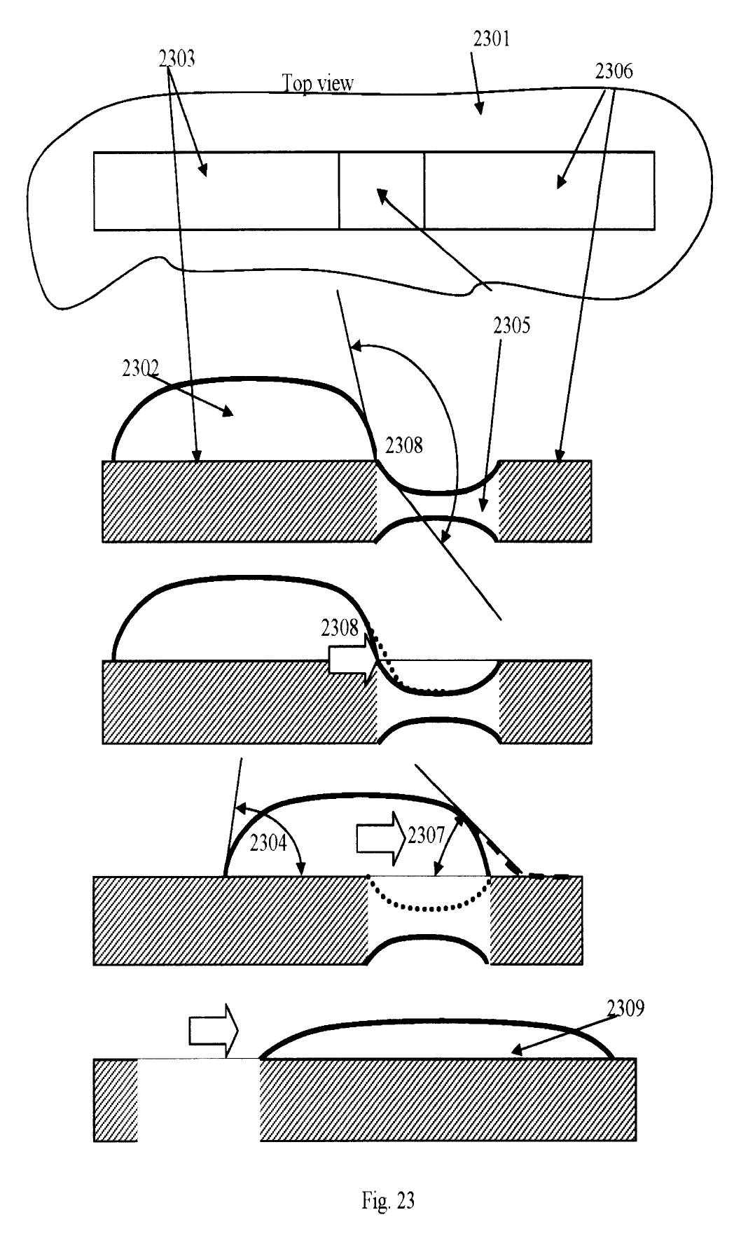

The same principle is places in design of combined apparatus that processes surface placed reagents. FIG. 23 helps to understand the principle of operations of such apparatus. The top surface of the apparatus body 2301 has low affinity to the liquid. First reagent 2302 occupies surface segment 2303. This surface segment has higher affinity to the liquid and has contact angle 2304 less then 90 degree. Cavity 2305 separates this surface segment from segment 2306. The cavity 2305 surface has lower affinity to the liquid than segment 2303. This prevents the first reagent from spontaneously occupying empty cavity. Segment 2306 has higher affinity to the liquid than segment 2301 or has smaller crossection length, and has contact angle 2307. Second reagent is introduced into the apparatus through the cavity 2305. The contact angle 2308 between meniscuses of the first and the second reagents shall be less than 180 degree. This causes meniscus to merge to meniscus 2308 to minimize surface free energy. This results in merger of reagents and causes the product to move into 2309 position.

This example is not limiting the apparatus to this particular implementation. It is only shown to demonstrate general principles of operations of such devices.

Use of Surface-Active Chemicals to Promote Liquid Actuation

The chemical compounds with structure A(X)R where R is a chemical structure with high affinity to the surface material, or ability to participate in chemical reaction with the surface with energy more than 1 kCal/mol, and A is a chemical structure with low energy of interaction with molecules of a solvent. The surface material shall be selected to have higher affinity to said solvent that affinity of said solvent to said chemical group A. Such compound or mix of compounds is introduced into small volume of solvent. The volume selected to be less or equal 10 microliters. Surface of the substrate shall have guide with said surface properties, the rest of the substrate's surface shall be separated from said guide by geometrical features or material with distinct surface properties.

This method allows a volume of liquid to propel itself along the guide. Propulsion speed and distance can be predefined by controlling an amount of the chemical compound introduced into the liquid and or single or combination of factors such as: liquid volume composition, substrate's temperature, liquid's temperature, electrical charge, environment composition and its conditions, substrate structure, etc.

Current embodiment uses term guide instead of more traditional term channel. Guide requires no enclosed volume and can be as simple as open surface segment, nevertheless any traditional micro channel or micro chamber are also consider to be guides as they are capable of constraining degrees of motion.

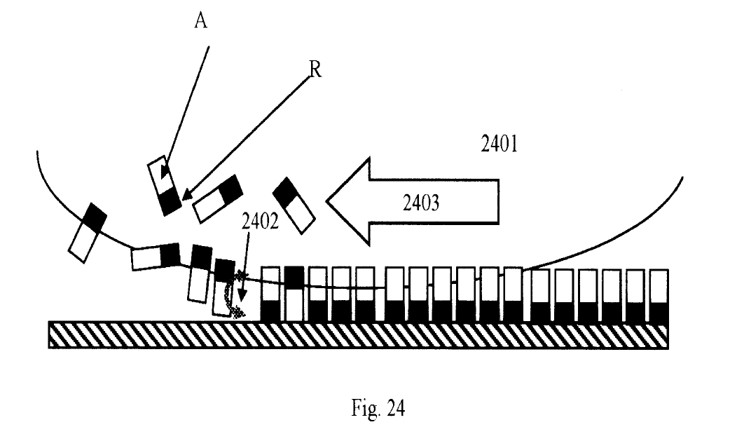

FIG. 24 illustrates this method. Chemical compound “AR” dissolved in the liquid micro droplet 2401. This liquid has areas of contact with the substrate. Due to affinity to the liquid this interaction 2402 causes reduction in surface free energy of the liquid volume. Compound “AR” comes into contact with the substrate in these areas. This is stochastic process and its rate of occurrence depends on diffusion rate of the compound in the volume and on the surface of the liquid volume. The compound forms association with the substrate by exposing its “R” chemical part to the substrate and its “A” part to the liquid. This orientation reduces energy of the compound and increases surface free energy of the liquid volume. The part of liquid volume exposed to contact with the substrate over longer period of time obtains higher surface free energy than the part exposed for sorter period of time. This results in the propulsion force 2403 that causes liquid volume to move. This process explains the self-propelled behavior of the liquid volume.

Reverse method of propulsion for the liquid volume, which was described in the beginning of this embodiment, is based on deposition of surface-active chemical on the substrate. The substrate surface shall have low affinity to the liquid and the chemical shall be deposited on the substrate to increase affinity to the liquid. The chemical shall be soluble in the liquid or shall change its chemical structure or/and composition due to interaction with liquid. This description also includes cases of using multiplayer structure of chemicals deposited on the surface of substrate. All structures except top layer are considered substrate in such cases.

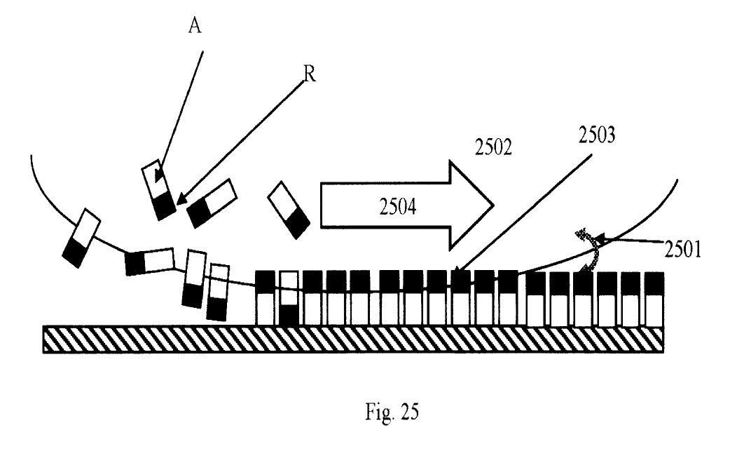

FIG. 25 illustrates this method. The chemical compound “AR” has chemical structure “R” that has high affinity to the liquid and thus reduces its free surface energy during initial contact 2501. Chemical structure “A” has low affinity to the substrate. Liquid volume 2502 placed on monolayer 2503 of this compound experiences reduction in its free surface energy. With course of time the monolayer structure deteriorates because of some of the following factors: thermal motion and/or flip-flop transformations, diffusion and/or solubilisation of the compound in the liquid, degradation and/or changes in structure of the compound due to interaction with liquid. This results in increase of free surface energy of the liquid volume. Because monolayer degradation depends on time of its interaction with said liquid, the parts of said liquid volume with longest exposure has higher surface energy than areas that have shorter exposure time. This results in the force 2504 that causes liquid volume to move. This process explains the self-propelled behavior of said liquid volume.

It is surprising to note that same chemical AR can be used to propel two distinct liquids. First liquid like water can have low affinity to hydrophobic group of said chemical and thus micro droplet of water containing said chemical such as SDS will be propelled on hydrophilic surface of such as glass. Disposition of micro droplet of hexane into the same guide will show self-propelled behavior of said second micro droplet as hexane removes layer of SDS previously formed by first water droplet.

It is also obvious that motion of droplet containing said chemical is limited by amount of said chemical in the droplet. Disposition of plurality of dispensing and mixing devices along selected guide can be used to refill said droplet with different types of propelling chemical. This allows said micro droplet to traverse unlimited distance.

Use of two or more propelling chemicals with different compositions allows said micro droplet traverse across different substrate surfaces. As an example micro droplet may contain thiols and lipids that will allow micro droplet to be propelled on glass as well as gold surfaces.

Methods disclosed in the present embodiment have important advantage over existing active methods of transport that were disclosed in prior art. All methods disclosed herein require no external energy source and do not depend on conductivity of liquids. These advantages allows simplification of design of microfluidic systems and their further cost reduction.

Surprisingly disclosed method has one special implementation that most beneficial in enclosed micro channels. This implementation uses absorption of vapors of surface-active chemicals from vapor phase rather than from substrate or liquid. Device that implements this method comprises at least one micro channel that has input and output ports. Micro droplet of fluid disposed in said channel and source of said vapors is disposed in said device in a way that concentration of said vapors became different near opposite meniscuses of said droplet. Event in absence of any gross pressure gradient said micro droplet is propelled by alteration of surface tension of said meniscuses that is caused by uneven absorption of said vapors. Simple illustration of disclosed system will be use of ethyl ester vapors to propel micro droplet of water based fluid in grass micro channel.

Another beneficial advantage of this method of invention is ability to precisely tune propulsion force and even reverse it when desired. This reversal can be achieved by reduction of concentration of said vapors that causes uneven diffusion of said chemicals from different surfaces of said micro droplet, and results in propulsion force caused by gradient in surface tension.

Liquids Discriminator

The apparatus has single intake guide and exactly two exit guides. Downstream end of said intake guide is completely symmetric with respect to centerline passing in downstream direction. All exit guides are made with identical shape and sizes and completely symmetric with respect to said centerline. There is at least one surface region on one of exit guides that has surface properties that distinct from some surface region of another exit guide.

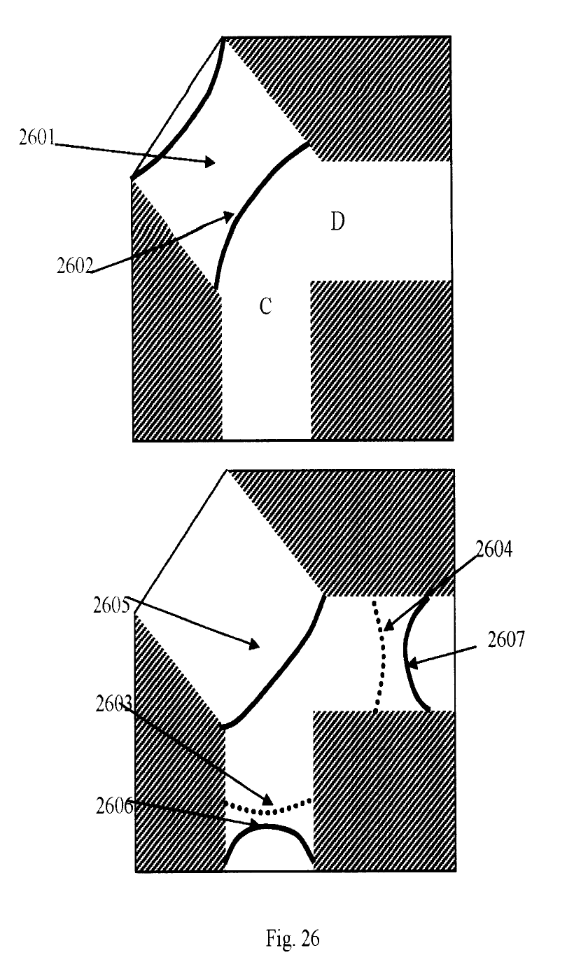

FIG. 26 helps to understand steps of operations of this apparatus. The volume of liquid 2601 directed to the apparatus reaches intersection 2602 of said guides. Geometry and surface properties of said intersection designed the way that liquid experiences no increase in surface energy when transferred from intake to exit guides 2603 and 2604. This design prevents meniscus 2605 of said liquid from breaking on two sub-volumes. The shapes of meniscuses 2606 and 2607 are defined by interactions between said liquid and surfaces of said exit guides.

Surfaces of said exit guides contain specific regions that cause changes in surface free energy of said meniscuses. In one case said regions can be designed to interact just with solvent substance of said liquid, example of this will be small surface area in guide 2604 covered with polystyrene while the rest of guides is acrylic. In this case said discriminator sends droplet with high concentration of esters to 2604 guide and droplet with low concentration of esters to 2603 guide. In another case said regions can be designed to interact with components of said liquid that presented in very small proportion, example of this will be small surface area in the guide 2307 covered with Au while identical area in the guide 2603 covered with Pb. In this case a droplet with trace amount of thiols will be stopped at discriminator and, within time defined by diffusion rate of thiols, monolayer of them will be formed on gold surface that will cause increase of surface free energy in guide 2604. This causes droplet to move by 2603 guide.

Particular implementation of the apparatus can be designed based on types of the liquids and their components that need to be sorted using this apparatus. For liquids with similar properties it is critical to produce exit channel with high accuracy.

Application of this apparatus comprises variety of discriminating compounds that is not limited by antibodies, detergents, lipids, self-assembling compounds.

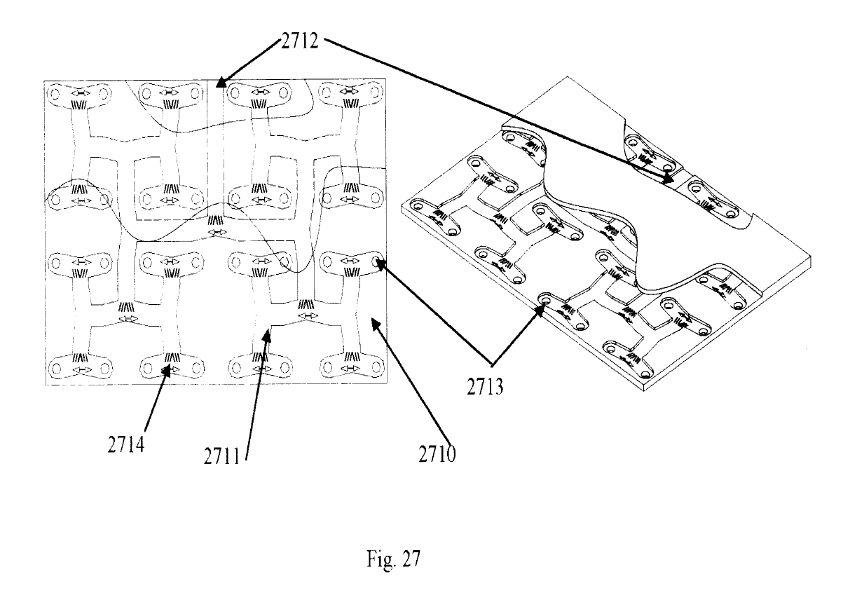

FIG. 27 shows example of multiway discriminator device that implements fractal layout of devices that similar to one shown on FIG. 26. Device body 2710 made from Acetal and has plurality of enclosed microchannels 2711 created by means of micro molding. Device comprises single input port 2712 and plurality of exit ports 2713. Each Y channel's intersection represents single device similar to one shown on FIG. 26. A distinct pairs of discriminating substances 2714 is disposed in each said intersection. A droplet of water based fluid with complex composition disposed in said device through channel 2712. Said droplet may be propelled by diffusion of ethyl ester vapors as disclosed in previous embodiment. Depending on composition of said droplet it will reach specific exit port 2713.

Surprisingly use of fractal like structures for design of sorting devices provides significant advantage in efficiently area or volume use of said devices and simplifies design, since same rules of discrimination can be applied at all scales of features of said devices and likeness laws can be efficiently applied.

Metastable Microenvironment Chamber

This embodiment uses term substrate to refer to any device or apparatus or any other physical component that uses small volumes of liquid with volumes less that 10 microliters, and exposes surfaces of this liquid volumes to gas and/or vapor phase. Term “Operating environment” refers to conditions of gas and/or vapor mixture which are acceptable as an operating conditions/environment for third party equipment.

This embodiment describes the invention of apparatus that controls pressure of vapors of a solvent at high precision, and precisely maintains relative vapor pressure of said vapors over the substrate surface in range from 90% to 105%. This apparatus allows performing operation on said liquid volumes in not enclosed state over extended period of time. The apparatus creates local controlled space of gaseous compounds around the substrate with high content of said liquid vapors, wherein said vapors can be even oversaturated. Apparatus may remove vapors away from space surrounding the controlled volume. It controls temperature of the substrate adjacent to said controlled volume. The substrate temperature adjusted in range from crystallization point of selected compound solvent to its boiling point at specific pressure. The temperature of said controlled volume is adjustable wide range.

This apparatus has several crucial distinctions from any existing environment control apparatus. It controls environment on the surface of the substrate rather than in a volume. It is capable of stabilizing metastable supersaturated conditioned for vapors in direct vicinity of the surface.

These peculiarities of the apparatus allow reproducible operations of all apparatuses the present invention. It also allows usage of standard instruments and equipment that requires standard operating conditions in conjunction with those apparatuses.

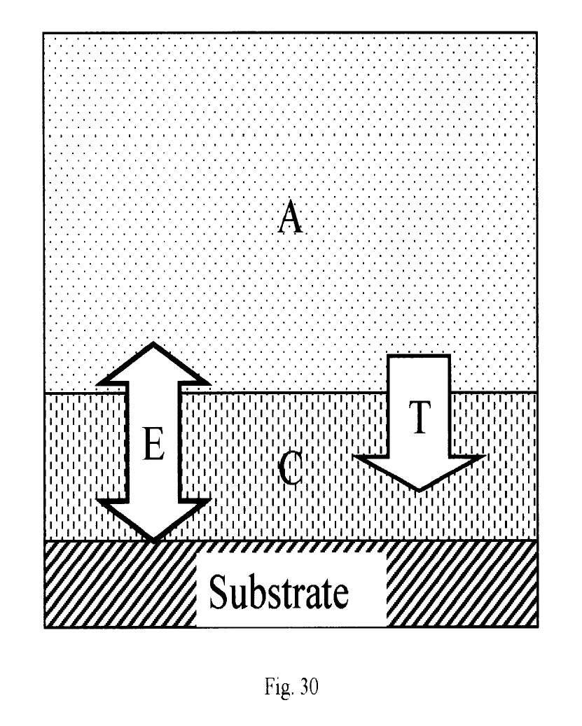

The physical diagram of one aspect of operation of the apparatus is shown on FIG. 30. Vapor in volume “A” surrounding the substrate exchanges heat with the surface “E” this causes local temperature changes in volume “C” that occupies space in direct proximity with the surface. Due to this gradient in temperature local pressure of vapors in volumes “A” and “C” become distinct, that causes diffusion “T” of vapor molecules toward or away from the substrate.

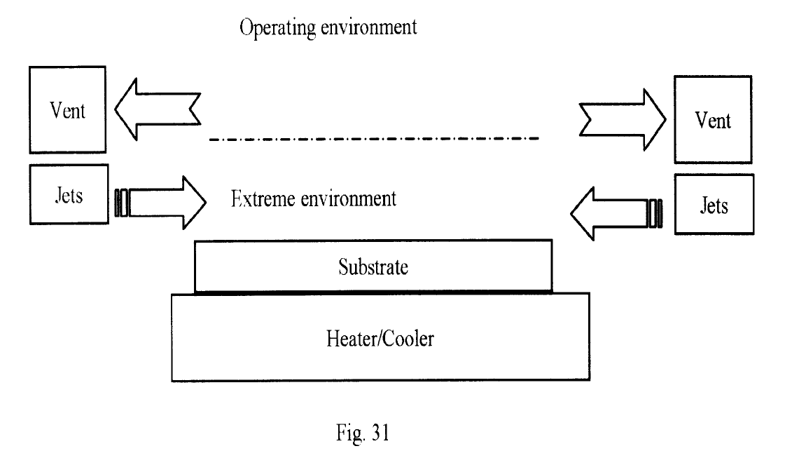

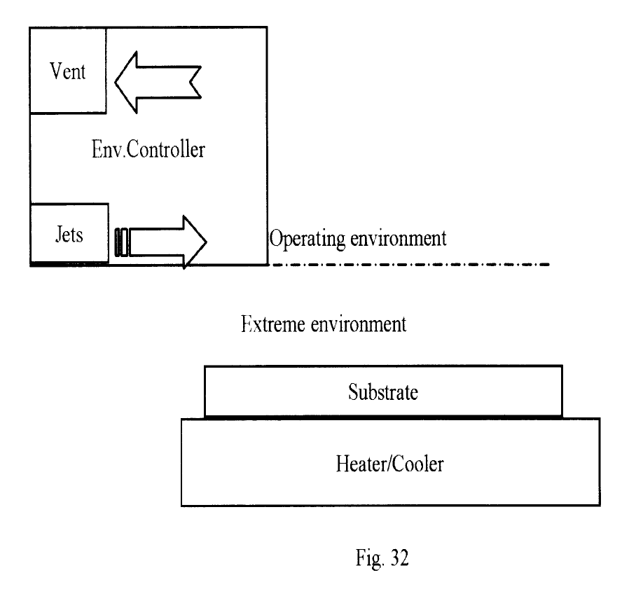

FIG. 31 illustrates yet another aspect of principle of construction of this apparatus. Substrate's temperature is directly driven by Heater/Cooler subsystem. This system controls and maintains temperature of the substrate according with desired conditions on its surface. Subsystem of jets located in direct vicinity of the surface of substrate. This subsystem provides gas phase components by injecting them into volume over the substrate surface. This subsystem controls relative composition of vapors and gases mix as well as its temperature. Vent subsystem located in proximity of the jet subsystem. It provides active gas exchange in the volume surrounding the substrate. This subsystem is optional for this apparatus. It maintains ambient conditions in the volume surrounding the essential parts of the apparatus. In limited case when desirable surface conditions can be achieved using gas phase of ambient environment the construction of the apparatus can be reduced to one shown on FIG. 32. Vent/jet subsystems combines into traditional environment control device that controls ambient environment around the substrate. Besides that, operation of the apparatus remains the same as in previously more general case.

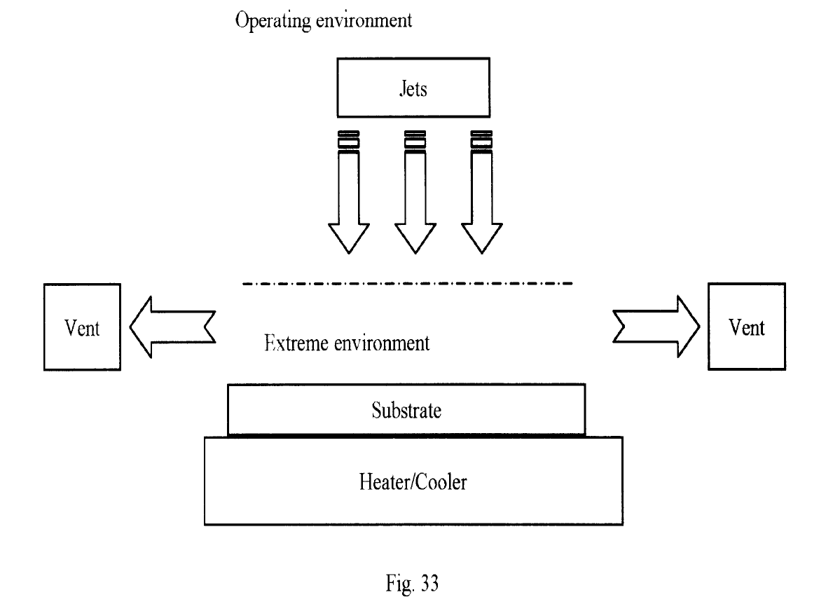

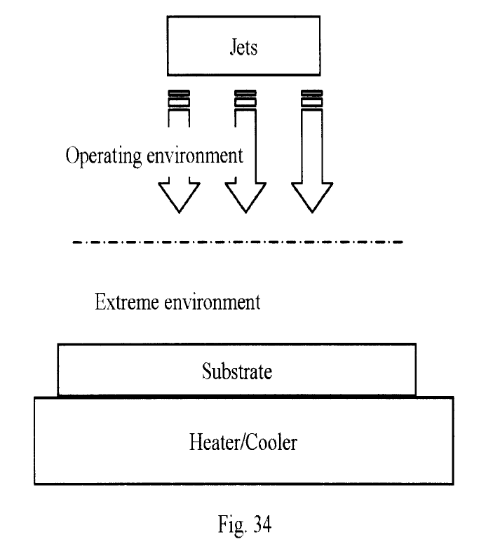

FIG. 33 shows alternative schema for one of possible implementation of this apparatus. The jet part located over the surface of the substrate, and provides required flow of gasses and/or vapors in the direction of substrate's surface. The vent system is located in proximity to the substrate and responsible for removal of excess of these gases/mixtures. In some cases such as case of water vapors it is possible to expose the operating environment to higher content of such vapors. One example of the apparatus implementation suitable for this case is illustrated on FIG. 34.

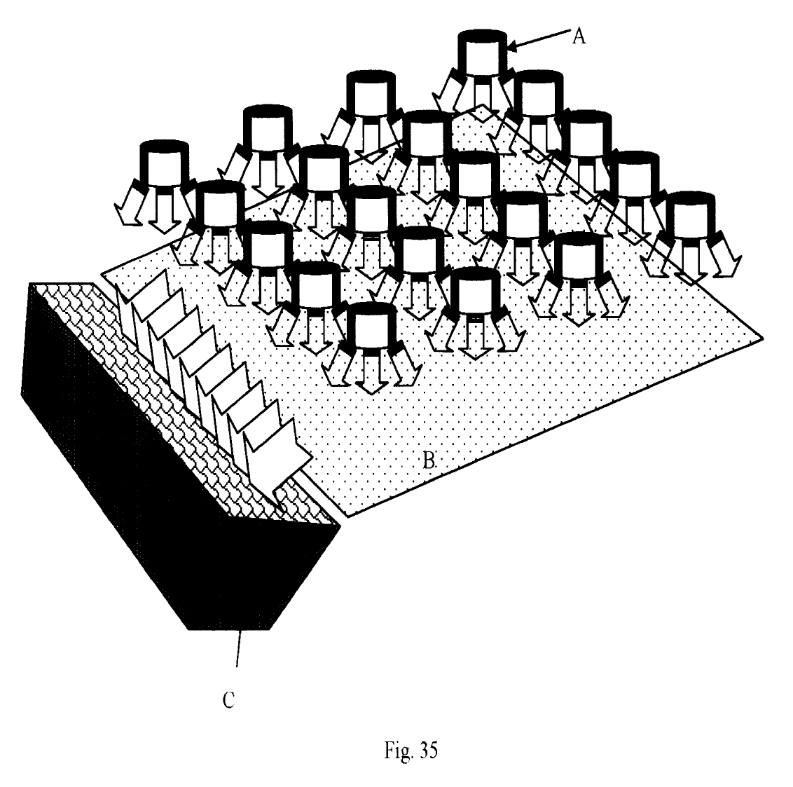

The constructions of the jet and vent parts of this apparatus varies depending on construction of third party dispensing and other equipment. Example on FIG. 35 shows an array “A” of miniature jet components located over the surface of substrate “B”. This configuration allows direct access to the surface while maintaining high uniformity of surface conditions. The vent system “C” provides stationary flow of gas mix away from the substrate and assist in maintaining conditions of the operating environment.

Yet another aspect of principle of construction of said apparatus includes use of flip-over design. This design places said apparatus in a way that gravitational pull deflects particles away from surface of said substrate. This principle also responsible for stabilization of supersaturated vapors that interface with said surface. In supersaturated conditions metastable vapors form microdroplets. This phenomena usually accelerated by presence of contaminating particles that serve as catalyst of said phase transition. In flip-over design said particles and microdroplets experience deflecting gravitational pull that rustics deposition of said entities onto said substrate.

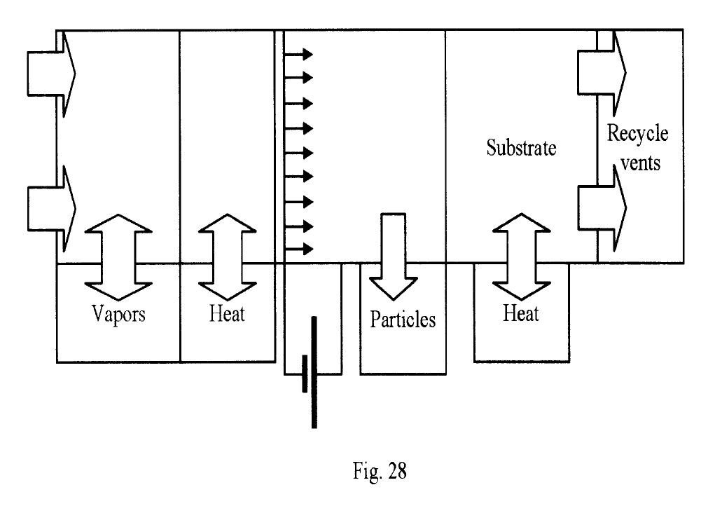

Yet another aspect of principle of construction of said apparatus is use of electrostatic jets. This principle is illustrated on FIG. 28. Inert gar passes left to right through the shown device. It enriched with desired vapors and excessive amount of undesirable vapors is removed, ant it passes through heat exchanger where temperature adjusted to substrate temperature. As it was described above this may bring said gaseous composite to oversaturated conditions. Said mix passes through electrostatic pump that propels said mix and charge suspended particles and droplets. Said suspension then precipitates and clean mix form laminar stream over the surface of said substrate, and then collected by recycle vents.

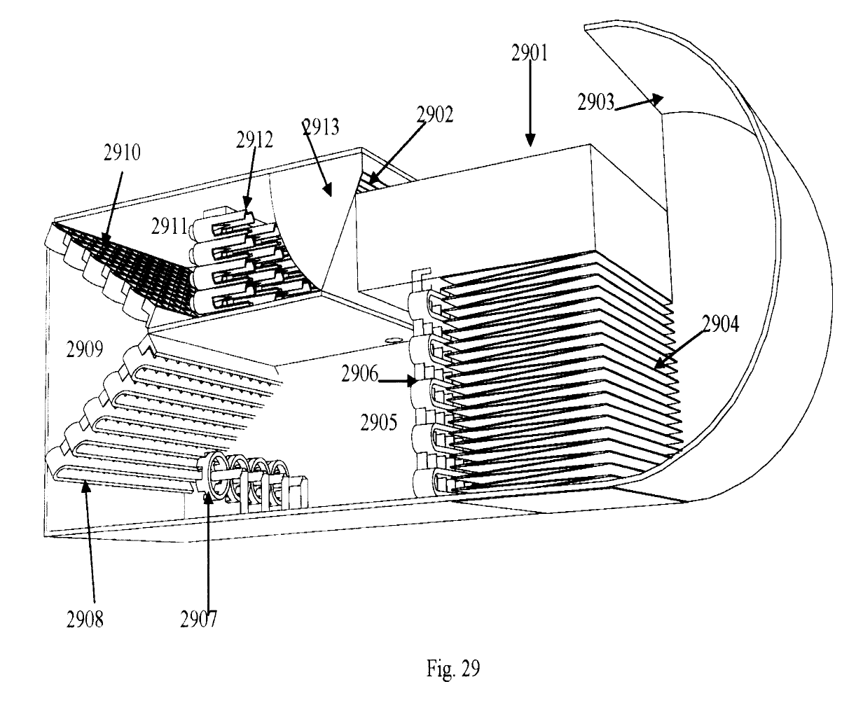

FIG. 29 illustrates complete example implementation of methods and principles disclosed herein. This picture shows only parts required for understanding of its operation and it is obvious to one skilled in the art how to complete this apparatus. As multiple variations are possible this drawing serves only as an example or guideline to implementations. Microfluidic device that handle non-enclosed volumes of fluids placed on thermal controlled surface 2901. Its surface maintained in laminar flow of gaseous mix disposed from port 2902 and recycled through port 2903. Gaseous mix passes through particle filter 2904 (i.e. HEPA filter) and enters enrichment chamber 2905 through heat exchanger 2906. In this example exchanger 2906 operates as a heater to increase temperature of gaseous mix. Array of ultrasonic jets 2907 dispense sufficient amount of required solvents to create environment of nearly saturated vapors inside chamber 2905. Formed mix passes through cooler 2908 which control a dew point of said vapors. This temperature is usually higher then temperature of substrates at 2901 that allows creation of oversaturated vapors. Chamber 2909 contains environment of saturated vapors that directed to heat exchanger 2910 that temperature precisely controlled to keep fixed difference with the substrate temperature at 2901. Chamber 2911 contains oversaturated vapor mixed that also carries microdroplets of said solvents that start to form. Array of ionic pumps 2912 ionizes and also pumps said gaseous mix through the apparatus. Fluid microdroplets carry electric charge that traps them in blades assembly 2913 before they reach open substrate at 2901. Electric potential of substrate surface 2901 is equal to ground potential and equal to potential of pumps 2912. Electric potential of blades assembly 2902 is highly positive (up to 30 KV).

Fiber Optical Microfluidic Manipulator

The present embodiment discloses an apparatus comprising plurality of microchannels and plurality of single or multimode optical fibers connected, wherein said fibers are connected to sources of laser light with wave lengths from infrared to ultraviolet, and said laser radiation is employed to manipulate chemical compounds in said apparatus.

This embodiment discloses plurality of devices that composes said apparatus and each of said devices represent the subject of the invention. Following examples illustrates physical principle that widely used throughout the embodiment. Droplet of buffer containing human interferon regulatory factor IRF6 with sequence RLKPWLVAQVDSGLYPGLIWLHRDSKRFQIPWKHATRHS disposed in micro channel. Concentration of said peptide is 1 mM and droplet volume is 1 femtoliter. Said channel has square crossection with one micron side. Said channel contains linear segment that interface with optical fiber collinear with said segment. Surface of said channel are hydrophobic and for simplicity of this example surface tension angle is 180°. Said optical fiber connected to single mode laser source with wavelength 280 nm. Molar extinction coefficient for said peptide is 18350 and its molecular weight is 3694. Said laser source emits 1 millisecond pulse with energy 100 mW.

Four microwatts of UV power will be absorbed by said peptides and will be converted to acceleration of 30 N/m² that would result in speed of 30000 microns per second and total travel distance of 15 microns. Nevertheless travel distance for said peptides is limited to dimension of said micro volume that is 1 micron. This will result is concentration of said peptides on downstream meniscus surface of said droplet and motion of whole micro volume. Acceleration of said droplet will be 0.14 m/sec² and travel distance 70 nanometers.

Use of infrared laser light source would increase absorption of light by water molecules instead of peptides. Using source of 3 micron IR radiation with same power in 10×10 micron channel causes efficient absorption and moves 100 femtoliter droplet over 300 microns.

Efficiency of described transport significantly increases with increase of absorbance of radiation with selected wave length by targeted substance. Due to high surface to volume ration of micro volumes of fluids in microfluidic devices temperature changes caused by absorbed radiation are usually negligible. Use of visible and UV light become increasingly favorable when dimensions of microfluidic channels approach micron and submicron range. Small dimensions of channels prevent propagation of infrared radiation described in the prior art.

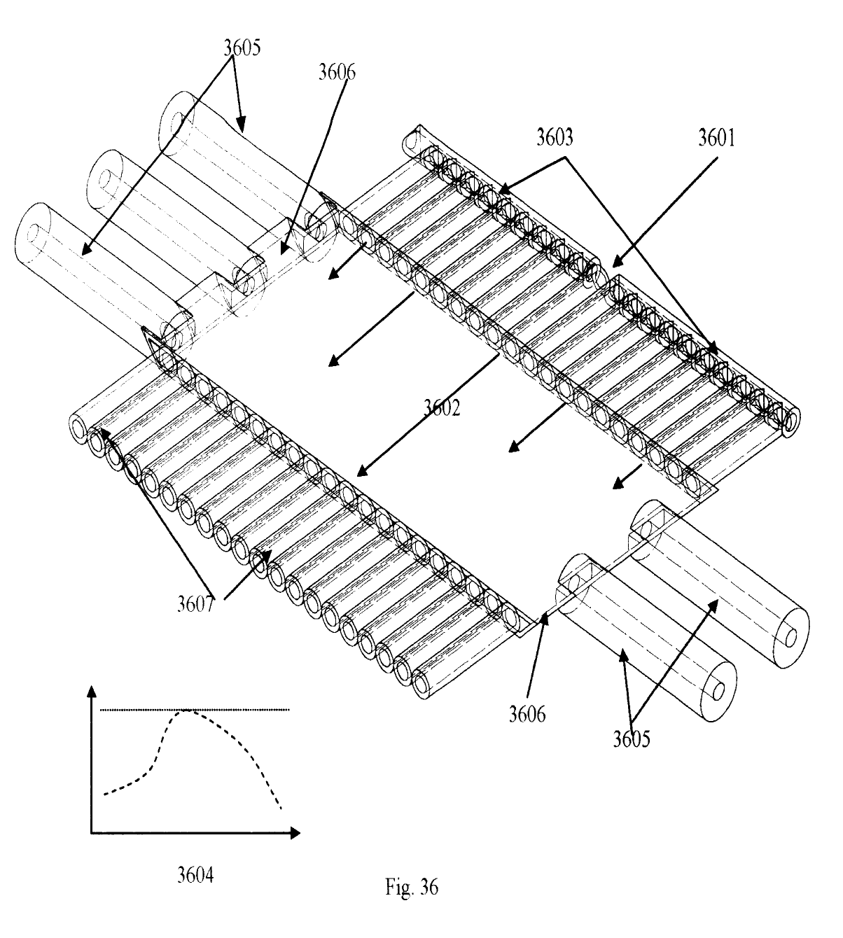

FIG. 36 shows an example of fiber optical concentrator that also performs discrimination of chemicals composing intake fluid. Illustration shows 1-to-20 concentrator. It is obvious for experienced in the art that number of outputs can be significantly increased. Mix of chemicals entering the apparatus through micro channel 3601. Position of said input port is shown to be in the middle of laminar field 3602. Such placement is not required and input port can be located at any chosen position. Plurality of laminar jets 3603 arranged to create laminar flow of solvent along the surface of field 3602. Distribution of flow rates through said jets can be designed according to specific task this apparatus used. Graph 3604 shows some example distributions that comprise constant as well as attenuating profiles. Plurality of optical fiber interfaces 3605 are located in direction normal to said laminar flow. Plurality of reflecting of adsorbing surfaces 3606 aligned with corresponding fibers. Exit ports collect fluid at specified rates. To illustrate operation of this apparatus lets consider input port supplies continuous flow of fluid carrying plurality of assorted sizes of red and blue micro particles. Consider that corresponding red laser sources connected to left side fibers and blue laser sources to the right side fibers. Each particle is exposed to sources of blue and red radiation but only matching wavelength is adsorbed which creates force normal to the laminar flow. Also particles with different sizes experience different amount of force. This difference in force and also viscosity and mass of the particle define distance of its deflection from initial input port stream. Described discrimination results in sorting of said particles. Red particles are deflected to the right and blue particles are deflected to the left. Smaller particles deflected further from initial laminar stream. In case when flow rate through secondary streams attenuates with distance from initial input stream 3601 this apparatus also performs function of concentrator, since sorted particles exit the apparatus through ports with smaller flow rate which means that said particles are contained in less amount of fluid.

It is obvious that example with particles is equally applicable to case of DNA or peptides fragments. In this case UV laser with 280 nm wavelength will perform discriminating and differentiating functions.

This is an example of fiber optical detector device that provides significant increase in sensitivity of various types of detectors comprising conductive, optical, etc. Apparatus comprises one or more optical fibers supplying UV or visible radiation to micro lenses that focus these beams at approximately the same point angles between optical axes of said lenses is between 90 and 180 degrees. Said focal point located upstream from location of said detector in microfluidic device. Let's consider an example of UV laser source. When it is activated it focuses and concentrates peptides or oligonucleotides. In case of single fiber said concentrating effect can be achieved on interface with the surface of said detector or micro channel. In case of multiple fibers their beams form trap volume that accumulates passing peptides or oligonucleotides. Laser can operate in impulse mode that synchronized with acquisition periods of said detector. In this mode material for detection will be accumulated in said trap until next acquisition time window and then released to the detector as a single batch. Adjusting the window length and period it is possible to increase detector sensitivity on several orders of magnitude. Consider this: Micro cannel has crossection area 100 sq. microns and optical detector with aperture 1 sq. micron and flow rate is 1 picoliter per second. Shutter rate of said detector set to 1/10 second and window size is 1/10 sec. Using disclosed apparatus sample is concentrated to volume 0.125 femtoliters over the period of 1/10 sec, thus increasing concentration 8000 times. Detector window time can be reduced to 1/100 sec due to synchronization with trap release event, which used to decrease of detector noise caused.

Thermo-Optical Coherent Microfluidic Manipulator

The present embodiment discloses a method of manipulating microdroplets and micro volumes of fluids in microfluidic devices using dynamic thermal field. Marangoni effect is essential part of this embodiment, it comprises in a fact that free surface energy of physical matter depends on its temperature and thus creation of temperature gradients causes disbalance in distribution of said energy that in many cases can cause physical displacement of said matter. Difficulty of use of said effect at micro scales comes from fact that due to small distances creation of reasonable thermal gradients requires sufficient power, on another hand said power density is hard to create using micro-scale devices. The present invention discloses method and device for creation of significant thermal gradients at micron and submicron scale. This method employs use of focused laser beams dynamically positioned over specific regions of microfluidic devices.

Following example helps to understand principle that widely used in the current embodiment. Surface of 100 micron film of HOPG (highly oriented pyrolitic graphite) holds single molecule of spherical dendrimer. Diameter of said molecule is 20 nm. Source of 280 nm laser with power 0.01 mW is focused on said surface and slowly moves to draw spiral with decreasing size at linear rate 1 m/sec. Initial diameter of said shape is 500 microns and it decays to 0.5 micron circle after one revolution. Substrate has X—Y thermal conductivity 1500 W/mK and Z thermal conductivity 10 W/mK, density 2.6 g/cm³, specific heat 0.8 J/gK. Laser is focused using micro lens to spot of 350 nm in diameter.

Rotating thermal field will have temperature gradient approximately 0.5 K per micron in X—Y direction that will result in temperature gradient on said dendrimer approximately 10 milli Kelvin. Rotating field produces focusing effect on said molecule and moves it into the center of rotation.

Disclosed method has several essential benefits not available in prior art. It allows creation of complex shapes of dynamic thermal fields on device that causes molecules and droplets to migrate to predefined locations so no monitoring of their motion is required. Because radiation interacts only with surface of substrate it provides thermal gradients significantly exceeding ones created by other methods. It allows manipulation of extremely small particles with volumes of yoctoliter scale.

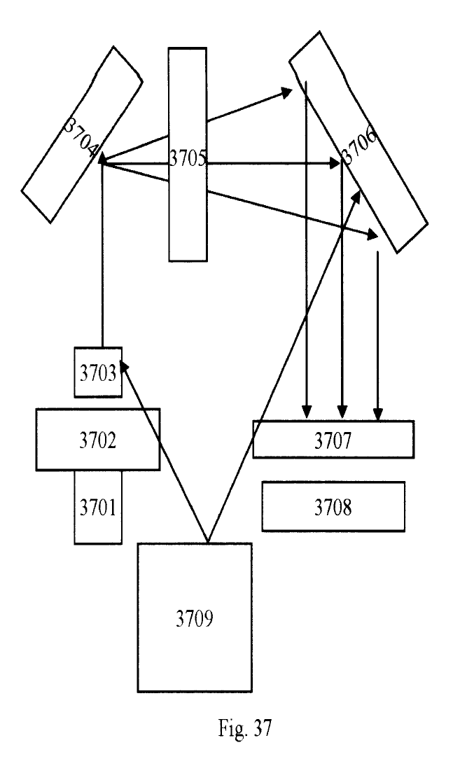

FIG. 37 show an example of apparatus that implements described methods. Source of laser light 3701 produces required radiation that passes through collimator 3702 and X—Y modulator 3703. Single beam passes through diffraction grid or other spatial modulator 3704 that allows creation of plurality of beams with desired power distribution. Said beams are converging through optical system 3705 onto digital light processing module (DLP) 3706. DLP allows dynamic switching of specific beams thus providing additional flexibility in apparatus employment. Plurality of active beams then focused by array of micro lenses 3704 onto desired surfaces of microfluidic device 3708. Operations of the apparatus are controlled by digital controller 3709. Controller provides algorithms for motions of X—Y modulator 3703 and DLP module 3706.

Construction of said microfluidic device comprises transparent interface side, wherein said transparency means that there are segments of surface of said device that made from material that has low adsorption of electromagnetic radiation of selected spectral range, wherein said range contains wavelength of said laser light, and said interface allows said light to be focused at least at some extent. Controller 3709 aligns its X—Y positioning operation in accordance with known geometry of said microfluidic device and in accordance with its current position. It is obvious to skilled in the art that standard alignment process may exist between said microfluidic device 3708 and disclosed apparatus, and in some implementations said process is as simple as precision holder for said device, while in others it may include additional X—Y—Z positioning means.

Disclosed method and device allows facilitation of geometry of dynamic thermal field and geometrical constraints of microfluidic device. For example radiation beam can simply follow trajectory of specific micro channel in said device that will cause corresponding motion of compounds located therein. Disclosed method allows not only propulsion of minute amounts of chemicals but also works as efficient tools allowing modification of composition of fluid micro volumes. Said modification is achievable by means of heating and cooling of specific areas inside microfluidic device or on its surface. Increase of temperature of micro droplet allows reduction of its volume due to increase evaporation of solvents. Said heating can be achieved by targeting current position of said micro droplets inside thermal or geometrical traps. Alternatively micro droplet can increase amount of solvent and its volume. This can be accomplished by allowing said droplet to cool down while increasing vapor concentration in surrounding volume. Said increase is achieved by heating liquid interface of source of said solvent. Disclosed apparatus may comprise thermal controller that maintain temperature of said microfluidic device at desired level.

Dynamically positioned light radiation can be used to other advantages as well. These advantages include but not limited to i) dynamic pressure source creatable by heating enclosed volumes containing liquids or gases; ii) concentration and separation of chemicals in a mix using photonic pressure as described in the previous embodiment; iii) modification of surface properties of micro channels and their components in said microfluidic device, which could include alteration of surface affinity to a solvent caused by reversible structural transformations of compounds composing said surface.

Disclosed apparatus can also use principles of laser propulsion disclosed in the previous embodiment, where in said propulsion can be achieved by alteration of direction of said radiation using optical or fiber-optical components of said microfluidic device to propel chemicals in desired direction.

Smart Microfluidic Devices

The subject of the present embodiment is efficient means of transferring and maintaining information that is specific to particular instance of microfluidic device. Such information is the most valuable in serial processing of large number of similar microfluidic devices. Important aspects of such information include but not limited to: i) geometrical dimensions and tolerances; ii) defects and their maps; iii) processing history of current device; iv) in-process data; v) device identification; vi) digital signatures, security and encryptions.

This information can be accessed through electrical, optical and event wireless remote access means. Method of storage of such information may include but is not limited to: i) electronic memory devices such as ROM, EPROM, RAM, FLASH, etc.; ii) optical memory storages such as CD-ROM and DVD-ROM, or write once devices such as CD-R, DVR-R, DVD+R, or rewritable devices such as CD-RW, DVD-RW, DVD+RW, herein no assumption is made that said optical storage technologies use standard format or implementations of listed commercial technologies, and it rather indication on principles of recording and/or reading information to/from physical surface by optical means; iii) optical storage technology based on bar codes.

Storage of information is an integral part of each instance of microfluidic device and can not be removed. Listed optical storage technologies based on bar codes represent optically writable surface where information can be recorded or modified and later retrieved with high fidelity associated with bar coding algorithm.

All patents, patent applications, and other published references mentioned herein are hereby incorporated by reference in their entirety as if each had been individually and specifically incorporated by reference herein.

While preferred illustrative embodiments of the present invention are described, it will be apparent to one skilled in the art that various changes and modifications may be made therein without departing from the invention, and it is intended in the appended claims to cover all such changes and modifications that fall within the true spirit and scope of the invention.

1. Microfluidic device comprising at least one cavity disposed within its body and at least two ports in connection with said cavity, wherein at least one port of each cavity faces same direction, and said microfluidic device is employed at some point as a temporary storage of fluids disposed into said cavity and storage period exceeds 15 seconds.

2. Microfluidic device of claim 1 comprising solid lid part, wherein said lid has at least one nearly flat surface, and said surface may form nearly airtight fixed contact with at least one port containing side of said device, and said contact is formed after disposing liquids into said device.

3. Microfluidic device of claim 1 comprising flexible lid part, wherein said lid has at least one nearly flat surface, and said surface may form nearly airtight fixed contact with at least one port containing side of said device, and said contact is formed after disposing liquids into said device.

4. Microfluidic device of claim 1 comprising solid lid part, wherein said lid has at least one nearly flat surface, and said surface may form nearly airtight contact with at least one port containing side of said device, and said contact is formed after disposing liquids into said device, and said lid can be removed from said device at least once without damaging or contamination of said device.

5. Microfluidic device of claim 1 comprising flexible lid part, wherein said lid has at least one nearly flat surface, and said surface may form nearly airtight contact with at least one port containing side of said device, and said contact is formed after disposing liquids into said device, and said lid can be removed from said device at least once without damaging or contamination of said device.

6. Microfluidic device comprising at least one cavity disposed within its body and at least two ports in connection with said cavity, wherein at least one port of each cavity faces same direction, and at least one other port of each cavity faces opposite direction, and said microfluidic device is employed at some point as a temporary storage of fluids disposed into said cavity and storage period exceeds 15 seconds.

7. Microfluidic device of claim 6 that comprises solid lid part, wherein said lid has at least one nearly flat surface, and said surface may form nearly airtight fixed contact with at least one port containing side of said device, and said contact is formed after disposing liquids into said device.

8. Microfluidic device of claim 6 that comprises flexible lid part, wherein said lid has at least one nearly flat surface, and said surface may form nearly airtight fixed contact with at least one port containing side of said device, and said contact is formed after disposing liquids into said device.

9. Microfluidic device of claim 6 comprising solid lid part, wherein said lid has at least one nearly flat surface, and said surface may form nearly airtight contact with at least one port containing side of said device, and said contact is formed after disposing liquids into said device, and said lid can be removed from said device at least once without damaging or contamination of said device.

10. Microfluidic device of claim 6 comprising flexible lid part, wherein said lid has at least one nearly flat surface, and said surface may form nearly airtight contact with at least one port containing side of said device, and said contact is formed after disposing liquids into said device, and said lid can be removed from said device at least once without damaging or contamination of said device.

11. Microfluidic device of claim 6 comprising two solid lid parts, wherein said lids have at least one nearly flat surface, and said surface may form nearly airtight contact with at least one port containing side of said device, and said contact can be formed after disposing liquids into said device.

12. Microfluidic device of claim 6 comprising two flexible lid parts, wherein said lids have at least one nearly flat surface, and said surface may form nearly airtight contact with at least one port containing side of said device, and said contact can be formed after disposing liquids into said device.

13. Microfluidic device of claim 6 comprising two solid lid parts, wherein said lids have at least one nearly flat surface, and said surface may form nearly airtight contact with at least one port containing side of said device, and said contact can be formed after disposing liquids into said device, and at least one of said lids can be removed from said device at least once without damaging or contamination of said device.

14. Microfluidic device of claim 6 comprising two flexible lid parts, wherein said lids have at least one nearly flat surface, and said surface may form nearly airtight contact with at least one port containing side of said device, and said contact can be formed after disposing liquids into said device, and at least one of said lids can be removed from said device at least once without damaging or contamination of said device.

15. Microfluidic device comprising at least one channel and said channel having at least one opening to nearly flat open surface, and said surface contains surface segment with high affinity to desired fluid and said surface segment is directly adjacent to said opening, and shape of said surface segment selected in such a way that shift of some liquid volume away from said opening causes reduction in contact area between said liquid and said surface shape, and said liquid volume is deposited on said surface from an external source, wherein said external source is any means or device that is not an integral part of said microfluidic device.

16. Microfluidic device comprising plurality of devices of claim 15 wherein some subset of said devices has openings oriented in nearly same direction and facing same or nearly coplanar surfaces.

17. Microfluidic device comprising at least one channel and said channel having at least one opening to nearly flat open surface, and said surface contains surface segment with high affinity to desired fluid and said surface segment is directly adjacent to said opening, and shape of said surface segment selected in such a way that shift of some liquid volume away from said opening causes reduction in contact area between said liquid and said surface shape, and said liquid volume is deposited on said surface from an external source, where is said external source is any means or device that is not an integral part of said microfluidic device, and said surface shape contains at least one feature with positive curvature that significantly higher than some other features of said shape, and said surface segment has electrical conductivity noticeably higher that adjacent surface regions, and said device is employed in such a way that said conductive surface feature caries electrical potential above +3 volts or below −3 volts, and said potential exists for more than 50 microseconds.

18. Microfluidic device comprising plurality of devices of claim 17 wherein some subset of said devices has openings oriented in nearly same direction and facing same or nearly coplanar surfaces.

19. Microfluidic device comprising:
i) at least one opening to a surface wherein said surface can be exposed partially or as a whole to a gas phase for at least some period of time, and said opening serves as a port allowing diffusion of vapors of a liquid solvent
ii) at least one opening supplying vapors of said liquid solvent to volume of space adjacent to said first opening, wherein concentration/pressure of vapor provided by this port is equal or exceeds concentration/pressure of vapors escaping through said first port.

20. Microfluidic device according to the claim 19 comprising a gel containing said solvent substance as a source of vapors for plurality of said second openings.

21. Microfluidic device according to claim 19 comprising porous inorganic material holding part of said solvent substance as a source of vapors for plurality of said second openings.

22. Microfluidic device according to claim 19 comprising integral chamber that holds said solvent substance as a source of vapors for plurality of said second openings.

23. Method of dispensing droplets of liquid with volumes less than one microliter onto nearly smooth surface, wherein said surface comprises plurality of ports and at least some of said ports are in liquid communication with integral chambers or channels, and said dispensing is carried out in gaseous environment containing at least 90% partial pressure of Helium gas, and said surface is later exposed to gaseous environment containing less than 10% partial pressure of Helium gas.

24. Microfluidic device comprising at list one chamber and said chamber comprising at least two ports, wherein said ports have openings to nearly flat surfaces, and normals of said surfaces are nearly parallel and there are at least two ports associated with the same chamber while having different area of cross section, and said device is employed during deposition of a liquid or a soluble substance to a surface of physical body positioned in direct proximity from at least on of said ports.

25. Microfluidic device according to claim 24 that is employed for deposition of said liquids or soluble substances to a surface of said physical body, wherein said body surface made from elastomeric material.

26. Microfluidic device according to claim 24 that is employed for deposition of said liquids or soluble substances to a surface of said physical body, wherein said body surface made from rigid material.

27. Microfluidic device comprising at list one chamber and said chamber comprising at least two ports, wherein said ports have openings to nearly flat surfaces, and normals of said surfaces are nearly counter parallel and there are at least two ports associated with the same chamber while having different area of cross section, and said device is employed during deposition of a liquid or a soluble substance to a surface of physical body positioned in direct proximity from at least on of said ports.

28. Microfluidic device according to claim 27 that employed for deposition of said liquids or soluble substances to a surface of said physical body, wherein said body surface made from elastomeric material.

29. Microfluidic device according to claim 27 that employed for deposition of said liquids or soluble substances to a surface of said physical body, wherein said body surface made from rigid material.

30. Microfluidic device that comprises:
i) at least one channel;
ii) cavity that has opening to said channel and is completely sealed otherwise, wherein surface of said channel has affinity to specific liquid higher than said exposed opening of said cavity, and said channel has at lease one downstream port and said downstream port creates passive energy barrier that is capable of stopping propagation of minute volume of said liquid, and energy required to overcome said barrier is lower than energy required for said liquid to cross region of said channel with said opening, and said cavity filled with fluid immiscible with said liquid or gas.

31. Microfluidic device comprising:
i) at least one channel;
ii) cavity that has opening to said channel, wherein surface of said channel has affinity to specific liquid higher than said exposed opening of said cavity, and said channel has at lease one downstream port and said downstream port creates passive energy barrier that is capable of stopping propagation of minute volume of said liquid, and energy required to overcome said barrier is lower than energy required for said liquid to cross region of said channel with said opening, and said cavity filled with fluid immiscible with said liquid or gas, and where said cavity has second opening or channel connecting said cavity with another volume containing said gas or fluid.

32. Microfluidic device comprising:
i) at least single channel;
ii) cavity that has opening to said channel and is completely sealed otherwise, wherein surface of said channel has affinity to specific liquid higher than said exposed opening of said cavity, and said channel has one downstream port that immediately adjacent to said opening and said downstream exposed to first segment of nearly flat surface and said first surface segment is surrounded by surface segments that have lower affinity to specific liquid than said first surface segment, and said cavity filled with fluid immiscible with said liquid or gas.

33. Microfluidic apparatus that employs ordered array of microfluidic devices of claim 30.

34. Microfluidic apparatus that employs ordered array of microfluidic devices of claim 31.

35. Microfluidic apparatus that employs ordered array of microfluidic devices of claim 32.

36. Microfluidic device comprising at least one surface and said surface comprising:
i) plurality of surface features that are capable of constraining mobility of micro volume of a liquid to single path;
ii) at least one surface feature that merges or intersects one of first surface features, and said surface features are employed in gaseous environment that contains nearly saturated vapors of said fluid.

37. Microfluidic device according to claim 36 wherein said second surface feature located on nearly flat surface region that is nearly coplanar with surface region containing first said feature.

38. Microfluidic device according to claim 36 wherein said second surface feature represented by port connected to surface cavity or micro channel located disposed in body of said microfluidic device.

39. Microfluidic device according to claim 36 that is employed for mixing of at least two reagents, wherein each reagent represented by minute amount and mixing operation completely consumes both reagents.

40. Microfluidic device according to claim 36 that is employed for mixing of at least two reagents, wherein each reagent represented by minute amount and mixing operation completely consumes at least one reagent and at least one reagent is consumed partially.

41. Method of passive propulsion of micro volume of a liquid, wherein said micro volume is less than one microliter and more that ten zeptoliters, and method of said propulsion uses loss of chemicals from said micro volume and said chemicals are other than solvent forming said micro volume, and said chemicals are deposited on a surface, wherein said surface interfaces with said micro volume and said chemicals alter energy of interaction between said solvent and said surface.

42. Method of passive propulsion of micro volume of a liquid, wherein said micro volume is less than one microliter and more that ten zeptoliters, and method of said propulsion uses gain of chemicals by said micro volume and said chemicals are other than solvent forming said micro volume, and said chemicals are deposited on a surface, wherein said surface interfaces with said micro volume and said chemicals alter energy of interaction between said solvent and said surface.

43. Method of passive propulsion of at least two distinct micro volumes of liquids, wherein both of said micro volumes are less then one microliter and more that ten zeptoliters, and method of said propulsion uses loss of chemicals by one of said micro volumes and said chemicals are other than solvent forming said micro volume, and said chemicals are deposited on a surface, wherein said surface interfaces with said micro volume and said chemicals alter energy of interaction between solvent of said first micro volume and said surface, and said propulsion uses gain of chemicals by another one of said micro volumes and said chemicals are other than solvent forming said second micro volume, and said chemicals are deposited on said surface by said first micro volume, wherein said surface interfaces with said second micro volume and said chemicals alter energy of interaction between solvent of said second micro volume and said surface.

44. Method of passive propulsion of micro volume of a liquid, wherein said micro volume is less than one microliter and more that ten zeptoliters, and method of said propulsion uses loss of chemicals from said micro volume and said chemicals are other than solvent forming said micro volume, and said chemicals are disposed in form of vapors from surface of meniscus of said micro volume, wherein said meniscus interfaces with surface of enclosed micro channel and said chemicals alter surface free energy of said solvent.

45. Method of passive propulsion of micro volume of a liquid, wherein said micro volume is less than one microliter and more that ten zeptoliters, and method of said propulsion uses absorption of chemicals by said micro volume and said chemicals are other than solvent forming said micro volume, and said chemicals are transferred in form of vapors to surface of meniscus of said micro volume, wherein said meniscus interfaces with surface of enclosed micro channel and said chemicals alter surface free energy of said solvent.

46. Method of claim 41 wherein said micro volume contains at least two chemicals that both contribute to said passive propulsion.

47. Method of claim 44 wherein said micro volume contains at least two chemicals that both contribute to said passive propulsion.

48. Method of claim 45 wherein said vapors contain at least two chemicals that both contribute to said passive propulsion.

49. Microfluidic device comprising at least one micro channel, wherein method of claim 41 is employed to move minute volumes of liquid in said micro channel.

50. Microfluidic device comprising at least one micro channel, wherein method of claim 42 is employed to move minute volumes of liquid in said micro channel.

51. Microfluidic device comprising at least one micro channel, wherein method of claim 43 is employed to move minute volumes of liquid in said micro channel.

52. Microfluidic device comprising at least one micro channel, wherein method of claim 44 is employed to move minute volumes of liquid in said micro channel.

53. Microfluidic device comprising at least one micro channel, wherein method of claim 45 is employed to move minute volumes of liquid in said micro channel.

54. Microfluidic device comprising a surface with plurality of geometric features, and at least one feature employed as a constraint that restricts degrees of motion freedom of a micro volume of a fluid and said device employs method of claim 41 to move said volume along said constraint.

55. Microfluidic device comprising a surface with plurality of geometric features, and at least one feature employed as a constraint that restricts degrees of motion freedom of a micro volume of a fluid and said device employs method of claim 42 to move said volume along said constraint.

56. Microfluidic device comprising a surface with plurality of geometric features, and at least one feature employed as a constraint that restricts degrees of motion freedom of a micro volume of a fluid and said device employs method of claim 43 to move plurality of fluid volumes along said constraint.

57. Method of sorting of micro droplets of a fluid, wherein said microdroplets have volume between one microliter and ten zeptoliters, and said sorting is done based on exposure of plurality of chemical compound of said fluid on surface of said droplet, and effect of said exposure on interaction energy between said droplet and at least one surface region of a substrate contacting with said droplet, and said sorting results in geometrical motion of said droplets by distinct trajectories.

58. Method of sorting according to claim 57, wherein at least one of said compounds is amphiphilic.

59. Method of sorting according to claim 57, wherein at least one of said compounds present in amount between 0.5 and 5 percent by mass in said droplet.

60. Method of sorting according to claim 57, wherein at least one of said compounds present in amount between 0.05 and 0.5 percent by mass in said droplet.

61. Method of sorting according to claim 57, wherein at least one of said compounds present in amount between 0.005 and 0.05 percent by mass in said droplet.

62. Method of sorting according to claim 57, wherein at least one of said compounds present in amount between 0.0005 and 0.005 percent by mass in said droplet.

63. Method of sorting according to claim 57, wherein at least one of said compounds present in amount less than 0.0005 percent by mass in said droplet.

64. Microfluidic device for manipulating micro droplets of fluids that comprises plurality of microchannels and their intersections, and said intersections comprise intersections that have geometrical plane or axis of symmetry oriented parallel to flow direction, and said device employs the method of claim 57.

65. Microfluidic device for manipulating micro volumes of fluids that comprises plurality channels or surface features that has fractal like structure and is employed for purpose of sorting or analysis of continuous or discrete micro volumes of said fluids.

66. Method of controlling evaporation rate of solvents from non-enclosed surfaces of micro volumes of fluids, wherein said micro volumes are disposed in microfluidic device or on any substrate with generally flat surface and said fluids have a part of surface interfacing with gaseous compounds and said gaseous compounds exist in unsealed space, and said method uses temperature difference between said fluids and said gaseous compounds to induce directed diffusion of said gaseous compounds toward said interface, and wherein each volume of said single fluid are less then ten microliters.

67. Method of deposition of microdroplets of fluids into microfluidic device or onto any substrate with generally flat surface, wherein said microfluidic device or substrate has higher gravitational potential energy than source of said fluids at the moment of transfer and each volume of said single fluid is less then ten microliters and target surface region of said substrate or microfluidic device is oriented toward said source.

68. Method of controlling evaporation rate of solvents from non-enclosed surfaces of micro volumes of fluids, wherein said micro volumes are disposed in microfluidic device or on any substrate with generally flat surface and said fluids have a part of their surface interfacing with gaseous compounds and said gaseous compounds exist in unsealed space, and said unsealed space is in gaseous connection with laminar flow of gaseous media that contains vapors of some of said compounds at concentration at least 98 present of maximum stable concentration of said vapors at current pressure and temperature of said stream.

69. Apparatus implementing method of claim 66 and has no automated means for replacement of said microfluidic device or substrate.

70. Apparatus implementing method of claim 67 and has no automated means for replacement of said microfluidic device or substrate.

71. Apparatus implementing method of claim 68 and has no automated means for replacement of said microfluidic device or substrate.

72. Apparatus implementing method of claim 66 that comprises:
i) feed-forward control means to adjust temperature of said microfluidic device or substrate to temperature required by said method without overshooting;
ii) means for automated placement and removal of said microfluidic devices or substrate onto said apparatus.

73. Apparatus implementing method of claim 67 that comprises means for automated placement and removal of said microfluidic devices or substrate onto said apparatus.

74. Apparatus implementing method of claim 68 that comprises means for automated placement and removal of said microfluidic devices or substrate onto said apparatus.

75. Apparatus for precision control of temperature and concentration of at least one vapor in gaseous volume, where in said volume is not sealed and has opening that at least one eight of its total surface and is less then ten centimeters in at least one dimension, and is designed to maintain relative pressure of said vapors above 90 percent in said volume and prevent said vapors from uncontrolled escape from said volume that could raise their concentration above 80 percent in any adjacent location besides said volume.

76. Apparatus that comprises:
i) electrostatic ionization source and oppositely charged electrode, where in said source and said electrode are positioned in a stream of saturated vapors of some compound and said source is located upstream and said electrode is located downstream;
ii) support member located downstream from said source and capable of holding or supporting microscale substrate or device, where in said substrate or device has artificially created features and at least one of them has dimension less than one millimeter.

77. Apparatus according to claim 76 and claim 75 further implementing methods according to claim 66 and claim 68, wherein said apparatus does not have any means for automated replacement of said microfluidic device or substrate.

78. Apparatus according to claim 76 and claim 75 further implementing methods according to claim 66 and claim 68, wherein said apparatus have means for automated replacement of said microfluidic device or substrate.

79. Microfluidic device comprising:
i) at least one microfluidic channel;
ii) at least one optical fiber integrated therein, wherein said optical fiber is capable of at least transmitting at least one milliwatt of at least single monochrome light that belongs to UV, visible or infrared ranges, and said light is penetrating volume of said channel and induces motion of chemical compounds or other physical matter that may include viruses and living cells in said channel.

80. Microfluidic device according to claim 79 wherein light source is laser with UV wavelength.

81. Microfluidic device according to claim 79 wherein light source is laser with visible wavelength.

82. Microfluidic device according to claim 79 wherein light source is laser with infrared wavelength.

83. Method of separation of different chemicals or distinct micro particles or other physical matter that may include viruses and living cells from a liquid mix wherein said mix forms a laminar flow and said flow is irradiated by one or plurality of sources of light in direction nearly normal to its flow.

84. Method of concentration of chemicals from a liquid mix wherein said mix forms a laminar flow and said flow is irradiated by one or plurality of sources of light in direction nearly normal to its flow.

85. Microfluidic device comprising:
i) single micro channel for input of liquid mix of chemicals or other physical matter that may include viruses and living cells;
ii) plurality of outputs;
iii) at least one optical fiber. Wherein there is a laminar flow of liquid in direction from said input channel to at least one output, and said optical fiber transmits light in direction nearly normal to said flow.

86. Microfluidic device comprising:
i) at least one micro channel and a detector associated with said channel;
ii) at least one optical fiber. Wherein light from at least one fiber intersects the volume of said channel and said light is focused, and in case of multiple fibers at least some of them have common focal points, and said focal point are located upstream from said detector.

87. Microfluidic device according to claim 86 wherein at least one light source for said fibers is synchronized with said detector.

88. Method of moving minute amounts of physical matter, wherein said matter comprises but not limited to individual molecules, fluids, solid or semisolid particles, live cells, viruses, and where in said method comprises use of coherent source of light and means of direction of said light onto device supporting said matter, and where in said light belongs to infrared, visible or UV range and said motion caused by gradient of temperature in proximity of said matter and said gradient is caused by absorption of said light.

89. Apparatus for manipulating minute amounts of physical matter in microfluidic device, wherein said apparatus comprises:
i) one or more sources of coherent light;
ii) some means for direction of said light;
iii) means for modulation of said light;
iv) microfluidic device or their plurality or predefined place for position of said devices;
v) digital controller or other digital processing device. Wherein said light sources are in infrared, visible or UV ranges, and said matter is living or not, and said means of modulation may include modulation of light intensity and/or position of beam or beams of light and/or splitting of single beam into multiple beams.

90. Method according to claim 88, wherein volume of said matter is more than one femtoliter.

91. Method according to claim 88, wherein volume of said matter is less than one femtoliter and more that one attoliter.

92. Method according to claim 88, wherein volume of said matter is less than one attoliter and more that one zeptoliter.

93. Method according to claim 88, wherein volume of said matter is less than one zeptoliter.

94. Apparatus according to claim 89, wherein modulation means include diffraction grid and array of digitally controlled micro-mirrors.

95. Apparatus according to claim 88, where in at least two light sources have different wavelength.

96. Microfluidic device integrated with memory device, wherein said memory device contains information specific to the instance of said microfluidic device, and where in said information contains at least one of the following:
i) geometrical dimensions and tolerances;
ii) calibration data;
iii) known defects;
iv) defects locations;
v) processing history;
vi) in-process data;
vii) access rights.

97. Microfluidic device of claim 96, wherein said memory device is semiconductor memory device.

98. Microfluidic device of claim 96, wherein said memory device is magnetic memory device.

99. Microfluidic device of claim 96, wherein said memory device is optical memory device.

100. Microfluidic device of claim 96, wherein said memory device is read only memory device.

101. Microfluidic device of claim 96, wherein said memory device is writing-once memory device.

102. Microfluidic device of claim 96, wherein said memory device is rewritable memory device.

103. Optical device comprising plurality of optical components and at least one source of coherent infrared of ultraviolet light and said optical components focus said light to plurality of focal points and said points are aligned with specified locations inside electrophoretic wells.

104. Optical device of claim 103 wherein power level changes of said light source are synchronized with voltage source for said electrophoretic system.

105. Optical device of claim 104 wherein said electrophoretic system is microfluidic device or is component of microfluidic device.
